(19) United States
(12) Patent Application Publication
(10) Pub. No.: US 2023/0418254 A1
(43) Pub. Date: Dec. 28, 2023

(54) GATEWAY DEVICE, GATEWAY CONTROL METHOD, AND NON-TRANSITORY COMPUTER READABLE MEDIUM

(71) Applicant: Mitsubishi Electric Corporation, Tokyo (JP)

(72) Inventor: Kiyohito MIYAZAKI, Tokyo (JP)

(73) Assignee: Mitsubishi Electric Corporation, Tokyo (JP)

(21) Appl. No.: 18/244,718

(22) Filed: Sep. 11, 2023

Related U.S. Application Data
(63) Continuation of application No. PCT/JP2021/017904, filed on May 11, 2021.

(51) Int. Cl. G05B 19/042

(52) U.S. Cl. CPC G05B 19/0428; G05B 2219/24024

(57) ABSTRACT

A gateway device (10) relays communication of safety data between a safety input/output unit (40) and a safety controller (20) that controls the safety input/output unit (40), and includes a state monitoring control section (130) and a safety control section (120). The state monitoring control section (130) manages a control state that is a state corresponding to a state of the safety control system (80) and is one of a safety state and a non-safety state, and controls a state transition of the control state by applying safety data that the gateway device (10) has received from the safety input/output unit (40) to state transition information that indicates a state transition concerning the control state. When the control state has transitioned from the non-safety state to the safety state, the safety control section (120) generates safety data that indicates the safety state and is to be transmitted to the safety input/output unit (40).

### CROSS REFERENCE TO RELATED APPLICATION

This application is a Continuation of PCT International Application No. PCT/JP2021/017904, filed on May 11, 2021, which is hereby expressly incorporated by reference into the present application.

### TECHNICAL FIELD

The present disclosure relates to a gateway device, a gateway control method, and a gateway control program.

### BACKGROUND ART

Safety control is control related to protection of workers, prevention of accidents, or the like, and is realized to ensure fail-safe characteristics. As a specific example, protection of workers is realized by interlock control of production equipment.

As a specific example, prevention of accidents is realized by temperature control in a chemical plant. A system that realizes safety control is called a safety-related system (SRS), and the requirements to be satisfied by safety-related systems are stipulated in the International Electrotechnical Commission (IEC) 61508 series and the like, which are international standards.

One aspect of important performance related to safety control is a safety response time. The safety response time is the time for a safety controller to react to an input of non-steady data into a system and for the safety controller to output data indicating a transition to a safety state. Non-steady data is information indicating that the system needs to be transitioned to the safety state. The safety state is, as a specific example, a state in which control for safety stop needs to be performed. The shorter the safety response time, the smaller a safety distance to a hazardous part of the production equipment can be designed. Therefore, the shortness of the safety response time contributes downsizing of the production equipment and so on.

Control in factory automation (FA) or process automation (PA) is realized by communication between distributed controllers and devices such as input/output units, so that it is realized by connecting the devices by a fieldbus, a field network, or the like. In communication of input/output data required for safety control, a safety communication technique is used for data to be communicated so as to implement special measures against communication errors. Processing for the measures against errors and so on is performed in safety communication, so that safety communication is one of the elements constituting the safety response time.

Products that respectively support a plurality of types of safety communication methods standardized in the IEC 61784-3 series are distributed on the market, and there is basically no interconnectivity between products that support mutually different safety communication methods. There are products on the market that convert safety communication methods in order to support a case where devices supporting mutually different safety communication methods are connected to build a production line.

Patent Literature 1 discloses a technique to shorten the safety response time in a safety network system that employs a safety communication method. In a system in which Patent Literature 1 is not applied, all pieces of safety information input to safety slaves are transmitted to a safety controller. Therefore, a problem is that if the number of safety slaves increases, a communication cycle time increases according to the number of safety slaves, making the safety response time longer. A safety slave is also called a safety input/output unit.

Therefore, a safety slave according to Patent Literature 1 includes safety determination means that determines whether safety conditions are satisfied based on a plurality of pieces of input safety information. The safety determination means is, as a specific example, means that can easily determine whether the safety conditions are satisfied by logical operations using input safety information. The safety slave transmits a determination result determined by the safety determination means, instead of the input safety information itself, to the safety controller. Therefore, according to Patent Literature 1, the amount of data to be transmitted to the safety controller is reduced, so that one cycle time can be shortened and, as a result, the safety response time can be shortened.

Patent Literature 1 does not limit the application of the above technique to safety slaves, and also discloses, as specific examples, a configuration in which the above technique is applied to a gateway that connects different types of fieldbuses and also a configuration in which a device other than a node, which is the transmission source of a determination result, is the transmission destination of a determination result.

### CITATION LIST

### Patent Literature

Patent Literature 1: WO 2003/001306 A1

### SUMMARY OF INVENTION

### Technical Problem

According to the technique disclosed in Patent Literature 1, the safety response time can be shortened through reduction of the amount of data to be transmitted. However, a problem is that if there is a large transmission delay in the communication path from the safety input/output unit to the safety controller, the safety response time cannot be shortened at a relatively low cost. One of the reasons for this is that the technique has the effect of improving a communication cycle, but does not have the effect of improving a communication delay.

As a specific example, there is a large transmission delay in the communication path when the system configuration is those indicated below. Although a transmission delay time generally has a range, a time that probabilistically guarantees acceptable reachability taking jitters into consideration will be called the transmission delay time, instead of the average or median value of transmission delays.

Configuration 1: A configuration involving an intra-site network with low punctuality. This network is, as a specific example, a network in which relay processing at a software level exists in the path, a network in which control for delay reduction, such as time slot management or quality of service (QoS) control, is not implemented, or a network that includes a wireless portion where a transmission collision may occur.

Configuration 2: A configuration in which the safety controller is located across a public network. As a specific example, a configuration in which the safety controller is located in a remote data center or on a cloud.

An object of the present disclosure is to shorten the safety response time at a relatively low cost even when there is a large transmission delay in a communication path from a safety input/output unit to a safety controller.

### Solution to Problem

A gateway device according to the present disclosure relays communication of safety data between a safety input/output unit and a safety controller that controls the safety input/output unit so as to establish a safety connection between the safety input/output unit and the safety controller, the safety input/output unit and the safety controller being included in a safety control system, and the gateway device includes a state monitoring control section to manage a control state that is a state corresponding to a state of the safety control system and is one of a safety state and a non-safety state, and control a state transition of the control state by applying safety data that the gateway device has received from the safety input/output unit to state transition information that indicates a state transition concerning the control state; and a safety control section to generate, when the control state has transitioned from the non-safety state to the safety state, safety data that indicates the safety state and is to be transmitted to the safety input/output unit.

### Advantageous Effects of Invention

According to the present disclosure, a gateway device is located between a safety input/output unit and a safety controller, and a safety control section generates safety data that indicates a safety state and is to be transmitted to the safety input/output unit. Therefore, according to the present disclosure, the time it takes for the safety data to arrive at the safety input/output unit can be shortened in comparison with a case where the safety controller transmits the safety data to the safety input/output unit. In addition, it is sufficient that a state monitoring control section has a function of determining whether a control state is a safety state or a non-safety state. Therefore, according to the present disclosure, a safety response time can be shortened at a relatively low cost even when there is a large transmission delay in the communication path from the safety input/output unit to the safety controller.

### BRIEF DESCRIPTION OF DRAWINGS

FIG. 1 is a figure illustrating an example of a hardware configuration of a safety controller 20 according to Embodiment 1;

FIG. 2 is a figure illustrating an example of a hardware configuration of a safety input/output unit 40 according to Embodiment 1:

FIG. 3 is a figure illustrating an example of a hardware configuration of a gateway device 10 according to Embodiment 1;

FIG. 4 is a figure illustrating an example of a hardware configuration of a setting terminal 50 according to Embodiment 1:

FIG. 5 is a figure illustrating an example of a configuration of a safety control system 80 according to Embodiment 1:

FIG. 6 is a figure illustrating an example of a configuration of a safety control section 120 and a state monitoring control section 130 according to Embodiment 1;

FIG. 7 is a figure describing a communication packet according to Embodiment 1:

FIG. 8 is a figure illustrating a specific example of control logic according to Embodiment 1;

FIG. 9 is a flowchart illustrating basic operation of the safety control system 80 according to Embodiment 1:

FIG. 10 is a figure illustrating basic operation of the gateway device 10 according to Embodiment 1:

FIG. 11 is a flowchart illustrating operation of the safety control system 80 according to Embodiment 1;

FIG. 12 is a figure illustrating characteristic operation of the gateway device 10 according to Embodiment 1;

FIG. 13 is a figure illustrating a specific example of a safety data mapping table 194 according to Embodiment 1;

FIG. 14 is a diagram illustrating a specific example of output definition information 191 according to Embodiment 1;

FIG. 15 is a flowchart illustrating operation of the safety control system 80 according to Embodiment 1;

FIG. 16 is a flowchart illustrating characteristic operation of the gateway device 10 according to Embodiment 1;

FIG. 17 is a figure illustrating a specific example of a state transition table 192 according to Embodiment 1; FIG. 18 is a flowchart illustrating operation of an engineering tool 30 according to Embodiment 1;

FIG. 19 is a figure illustrating a specific example of an overall state transition table according to Embodiment 1;

FIG. 20 is a table describing operation of the engineering tool 30 according to Embodiment 1;

FIG. 21 is a table describing operation of the engineering tool 30 according to Embodiment 1;

FIG. 22 is a figure illustrating a specific example of the output definition information 191 according to Embodiment 1; and

FIG. 23 is a figure illustrating an example of a hardware configuration of the gateway device 10 according to a variation of Embodiment 1.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in figures mainly indicate flows of data or flows of processing. “Unit” may be suitably interpreted as “circuit”. “step”, “procedure”, “process”, or “circuitry”.

### Embodiment 1

This embodiment will be described in detail below with reference to the drawings.

***Description of Configuration***

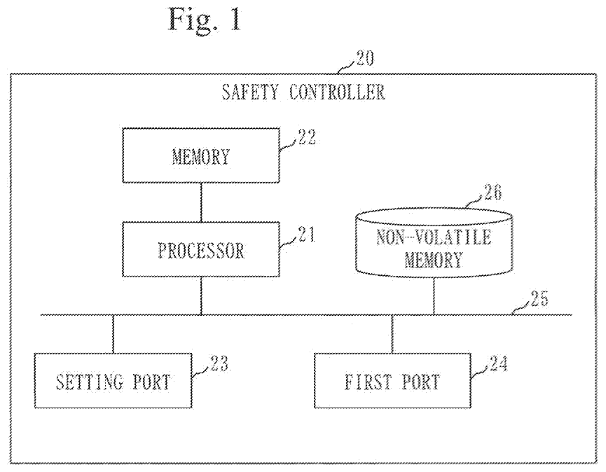

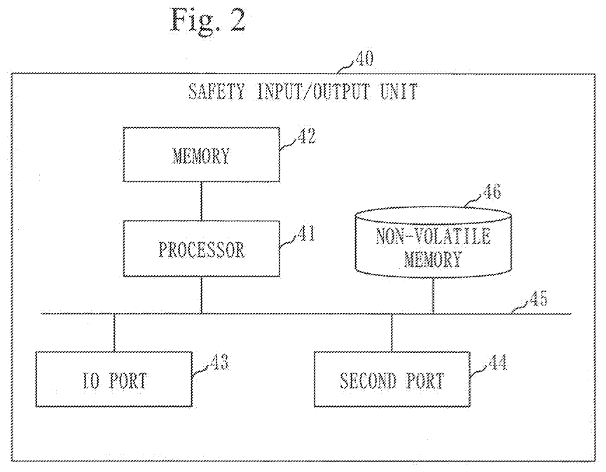

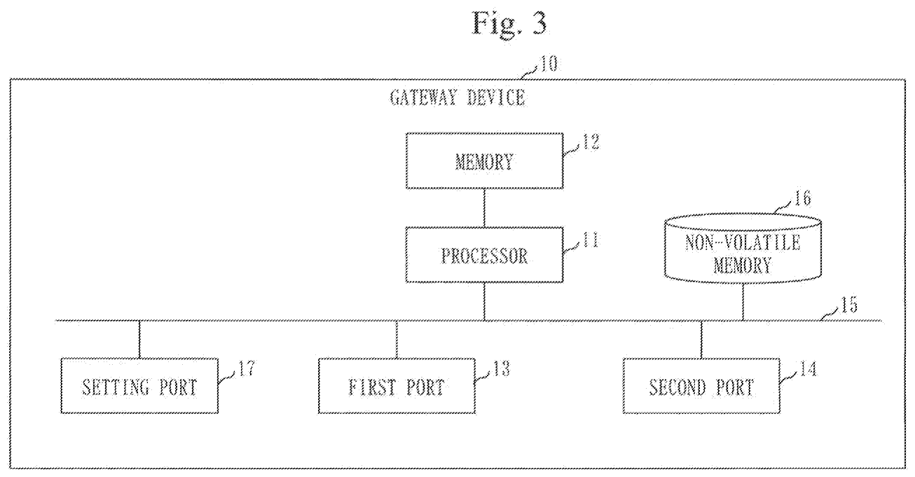

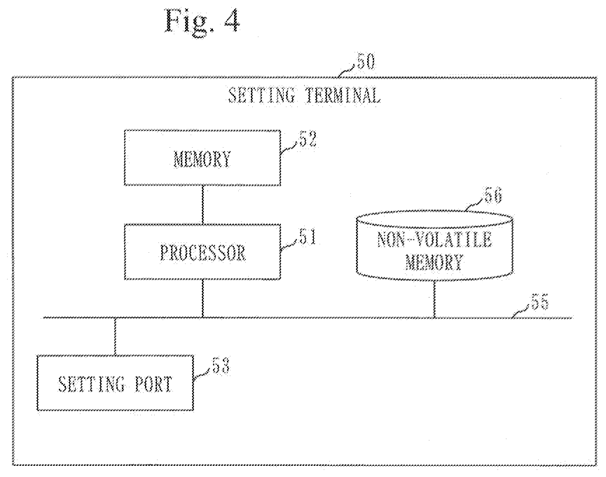

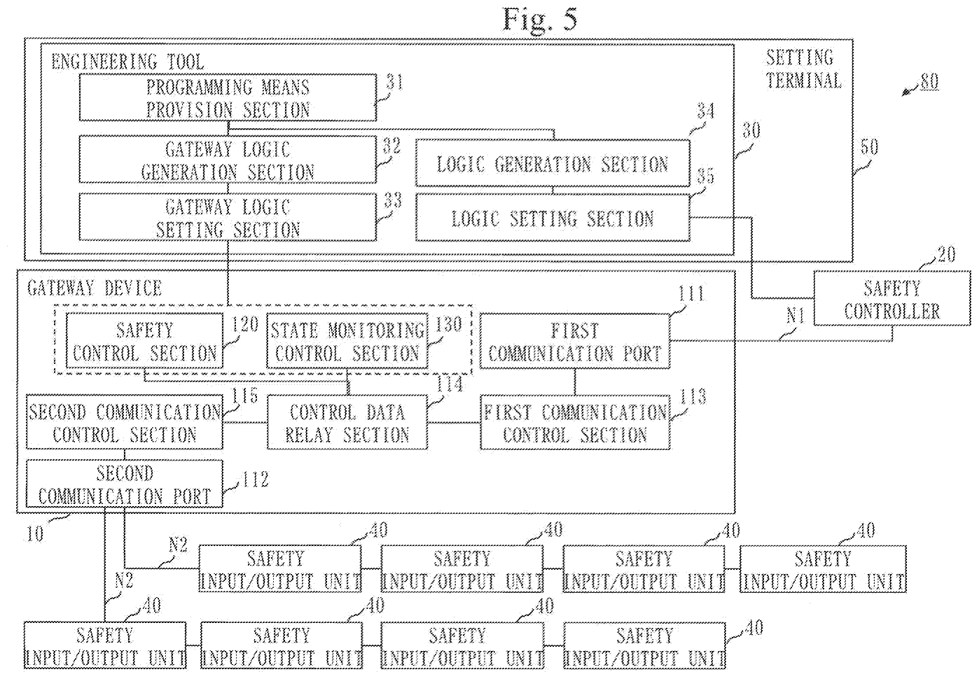

FIGS. 1 to 4 illustrate an example of hardware configurations of constituent elements included in a safety control system 80. The safety control system 80 includes a safety controller 20, a safety input/output unit 40, a gateway device 10, and a setting terminal 50. The safety control system 80 is a system related to safety control in the field of factory automation (FA) or process automation (PA). Each of the constituent elements is hardware developed in accordance with the requirements of a safety-related system (SRS), and is typically a computer. In order to meet a required safety integrity level (SIL), each of the constituent elements may be partially or wholly duplicated, or a device that is each of the constituent elements may be duplicated.

The safety controller 20 includes a processor 21, a memory 22, a setting port 23, a first port 24, a bus 25, and a non-volatile memory 26.

The processor 21 is an integrated circuit (IC) that performs operational processing, and controls hardware included in a computer. The processor 21 is, as a specific example, a central processing unit (CPU), a digital signal processor (DSP), or a graphics processing unit (GPU). The safety controller 20 may include a plurality of processors as an alternative to the processor 21. The plurality of processors share the role of the processor 21.

The memory 22 is, typically, a volatile storage device. The memory 22 is also called a main storage device or a main memory. The memory 22 is, as a specific example, a random access memory (RAM). Data stored in the memory 22 is saved in the non-volatile memory 26 as necessary.

The setting port 23 is a port for performing setting by an engineering tool 30. The setting port 23 is, as a specific example, a Universal Serial Bus (USB) terminal.

The first port 24 is a port that supports a communication method 1, and is a receiver and a transmitter. The first port 24 is, as a specific example, a communication chip or a network interface card (NIC).

The bus 25 is a signal line to realize internal communication.

The non-volatile memory 26 is, typically, a non-volatile storage device. The non-volatile memory 26 is, as a specific example, a read only memory (ROM), a hard disk drive (HDD), or a flash memory. The non-volatile memory 26 stores programs, parameters, and so on. Data stored in the non-volatile memory 26 is loaded into the memory 22 as necessary. The memory 22 and the non-volatile memory 26 may be configured integrally.

The safety input/output unit 40 is also called a safety input/output (I/O) or safety I/O device. I/O is also written as IO. The safety input/output unit 40 includes a processor 41, a memory 42, an IO port 43, a second port 44, a bus 45, and a non-volatile memory 46.

The processor 41 is substantially the same as the processor 21. The memory 42 is substantially the same as the memory 22. The second port 44 is substantially the same as the first port 24, except that it is a port that supports a communication method 2 instead of the communication method 1. The bus 45 is substantially the same as the bus 25. The non-volatile memory 46 is substantially the same as the non-volatile memory 26.

The IO port 43 is a port to accept data from a connected device and output data to a control device. The IO port 43 is, as a specific example, a USB terminal. The connected device is, as specific example, at least one of a sensor and a switch. The control device is, as a specific example, at least one of an actuator and a relay. The connected device and the control device may be configured integrally.

The gateway device 10 includes a processor 11, a memory 12, a first port 13, a second port 14, a bus 15, a non-volatile memory 16, and a setting port 17. The gateway device 10 is also called a safety gateway.

The processor 11 is substantially the same as the processor 21. The memory 12 is substantially the same as the memory 22. The first port 13 is substantially the same as the first port 24. The second port 14 is substantially the same as the second port 44. The bus 15 is substantially the same as the bus 25. The non-volatile memory 16 is substantially the same as the non-volatile memory 26, and stores a gateway control program. The setting port 17 is substantially the same as the setting port 23.

Any program described in this specification may be recorded in a computer readable non-volatile recording medium. The non-volatile recording medium is, as a specific example, an optical disc or a flash memory. Any program described in this specification may be provided as a program product.

The setting terminal 50 is a terminal to execute the engineering tool 30, which is software, and is, as a specific example, a commonly used personal computer (PC). The setting terminal 50 includes a processor 51, a memory 52, a bus 55, a non-volatile memory 56, and also a setting port 53.

The processor 51 is substantially the same as the processor 21. The memory 52 is substantially the same as the memory 22. The bus 55 is substantially the same as the bus 25. The non-volatile memory 56 is substantially the same as the non-volatile memory 26, and stores an engineering program.

The setting port 53 is substantially the same as the setting port 23, and is a port for setting programs, parameters, and so on in each of the safety controller 20 and the gateway device 10.

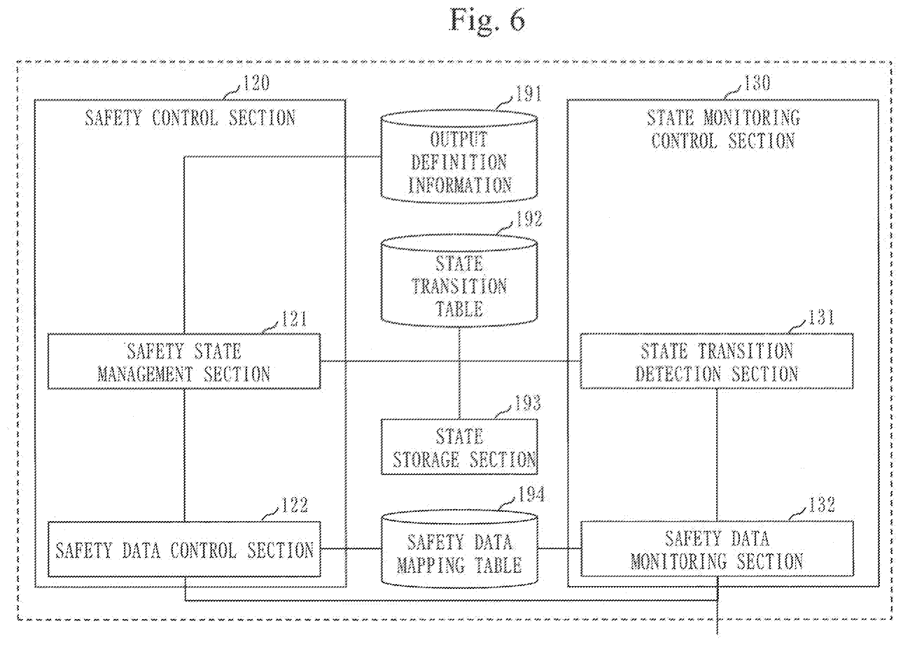

FIG. 5 illustrates an example of a configuration of the safety control system 80. Elements constituting the safety control system 80 may be configured integrally as appropriate. The functions of each constituent element included in the safety control system 80 are realized by software.

The safety controller 20 has functions of executing control logic based on an input from the safety input/output unit 40 and making an output based on a result of executing the control logic to the safety input/output unit 40. That is, the safety controller 20 controls the safety input/output unit 40. The control logic is an algorithm or the like to control the safety input/output unit 40. The safety controller 20 does not communicate directly with the safety input/output unit 40, and communicates with the gateway device 10 via the first port 24. The communication path between the safety controller 20 and the gateway device 10 is connected by a network N1. The network N1 is a network that supports the communication method 1.

The gateway device 10 is interposed on the communication path between the safety controller 20 and the safety input/output unit 40, and includes a first communication port 111, a second communication port 112, a first communication control section 113, a control data relay section 114, and a second communication control section 115. In addition, the gateway device 10 includes, as parts characteristic of this embodiment, a safety control section 120 and a state monitoring control section 130 that are connected with the control data relay section 114. The gateway device 10 establishes a safety connection between the safety input/output unit 40 and the safety controller 20 by relaying communication of safety data between the safety input/output unit 40 and the safety controller 20. The safety control section 120 is also called a safety-state activation and cancellation control section. The state monitoring control section 130 is also called a state machine monitoring control section.

Each of the first communication port 111 and the first communication control section 113 supports the communication method 1, and is realized by the first port 13.

Each of the second communication port 112 and the second communication control section 115 supports the communication method 2, and is realized by the second port 14.

FIG. 6 illustrates an example of a configuration of each of the safety control section 120 and the state monitoring control section 130.

The safety control section 120 includes a safety state management section 121 and a safety data control section 122. When the control state has transitioned from a non-safety state to a safety state, the safety control section 120 generates safety data that indicates the safety state and is to be transmitted to the safety input/output unit 40. The safety control section 120 may perform control to disconnect the safety connection when the control state has transitioned from the non-safety state to the safety state. While the safety connection is disconnected, the safety control section 120 may cancel the disconnection of the safety connection when the control state has transitioned from the safety state to the non-safety state. As control to disconnect the safety connection, the safety control section 120 may perform control to rewrite safety data that the gateway device 10 has received from the safety controller 20 so that the safety data indicates the safety state. The safety connection is disconnected because the gateway device 10 does not relay the safety data output by the safety controller 20 directly to the safety input/output unit 40.

The safety state is a state of being free from unacceptable risks, and is, as a specific example, a state in which workers are protected such as a state in which machine tools controlled by the control system are stopped, or a state in which the machine tools are operating at a safe speed. The non-safety state is a state in which an imminent risk is unacceptable, and is, as a specific example, a state in which a risk of harming workers is not sufficiently reduced. Each of the safety state and the non-safety state is expressed as an input/output value for the connected device connected under the safety input/output unit 40.

The state monitoring control section 130 includes a state transition detection section 131 and a safety data monitoring section 132. The state monitoring control section 130 manages the control state, and controls a state transition of the control state by applying safety data that the gateway device 10 has received from the safety input/output unit 40 to state transition information. The state transition information is information indicating a state transition regarding the control state. The state monitoring control section 130 may control a state transition of the control state by applying safety data that the gateway device 10 has received from the safety controller 20 to the state transition information. While the safety connection is disconnected, the state monitoring control section 130 may control a state transition of the control state without using safety data that the gateway device 10 has received from the safety controller 20 and that indicates a result of performing control based on safety data older than the safety data that has caused the safety connection to be disconnected. The state monitoring control section 130 may use partial control logic that is at least part of the control logic used by the safety controller 20. The state transition information may be information indicating at least part of the partial control logic. The state transition information may be information that is set using the engineering tool 30.

Processing performed by the gateway device 10 is mainly the following processing 1 to processing 3.

Processing 1: Processing of converting between the communication method 1 and the communication method 2.

Processing 2: Processing of overwriting an output indicating the non-safety state made by the safety controller 20 to the safety input/output unit 40 in response to an input of a non-steady signal from the safety input/output unit 40 so that the output indicates the safety state, and outputting the overwritten output to the safety input/output unit 40.

Processing 3: Processing of, after a transition to the safety state, switching priority from an output in the processing 2 to an output from the safety controller 20 so that an output to cancel the safety state from the safety controller 20 is reflected in the safety input/output unit 40.

The safety input/output unit 40 transmits, to the safety controller 20, safety data corresponding to an input value from the connected device connected under the safety input/output unit 40, and outputs data corresponding to safety data received from the safety controller 20 to the control device connected under the safety input/output unit 40. Safety data is also called safety I/O data, I/O data, or safety information. The safety input/output unit 40 does not directly communicate with the safety controller 20, and communicates with the gateway device 10 via the second port 44. The gateway device 10 and the safety input/output unit 40 are connected by a network N2. The network N2 is a network that supports the communication method 2.

The engineering tool 30 includes a programming means provision section 31, a logic generation section 34, and a logic setting section 35, and further includes a gateway logic generation section 32 and a gateway logic setting section 33 as parts characteristic of this embodiment. The engineering tool 30 can communicate with the gateway device 10. A user is a user of the safety control system 80. A control application is an application that realizes the functions of the safety control system 80, and is also called a safety control application. An application refers to an application program unless otherwise specified. The control application obtains a control state based on the control logic, and manages the obtained control state. The control state is a state that is indicated by the control application and is assumed as the state of the safety control system 80. The control state is also called an internal state. The control state is a state corresponding to the state of the safety control system 80, and is one of the safety state and the non-safety state.

The programming means provision section 31 provides the user with means to create a control program and parameters according to the control application that the user wishes to realize.

The logic generation section 34 generates control logic and parameters to be set in the safety controller 20 according to a processing result of the programming means provision section 31.

The logic setting section 35 sets the control logic and parameters generated by the logic generation section 34 in the safety controller 20.

The gateway logic generation section 32 generates control logic and parameters for realizing the operation stated in the description of the gateway device 10 according to a processing result of the programming means provision section 31.

The gateway logic setting section 33 sets the control logic and parameters generated by the gateway logic generation section 32 in the gateway device 10.

Each of the safety controller 20 and the safety input/output unit 40 may be an existing one. That is, the gateway device 10 may behave like the safety input/output unit 40 adopting the communication method 1 in relation to the safety controller 20, and behave like the safety controller 20 adopting the communication method 2 in relation to the safety input/output unit 40, so as to operate transparently.

The communication method 1 and the communication method 2 are basically different from each other, but the communication method 1 and the communication method 2 may be the same communication method. When the communication method 1 and the communication method 2 are the same communication method, the effect of converting a communication method cannot be obtained, but the effect of shortening a safety response time can be obtained by arranging that the gateway device 10 makes a proxy response to the safety input/output unit 40 like a cache server. The safety response time is the worst time from transmission of safety data by the safety input/output unit 40 to reception, by the safety input/output unit 40, of safety data corresponding to the safety data output by the safety input/output unit 40. The safety response time may include a time related to operation of a device, such as a time required for an actuator for reaction in a transition to the safety state.

As a supplement, it is widely practiced to mix safety control and other general control in the same system or network, and also in this embodiment, these types of control may be mixed in the safety control system 80. General control is, as a specific example, general 10 control or drive control. When these types of control are mixed, a device related to general control may be connected to the second communication port 112 in a mixed manner, at least one of a general 10 controller and a drive control controller, in addition to the safety controller 20, may be connected to the first communication port 111, and control logic related to general control may be integrated with control logic of the safety controller 20. In this case, it is also conceivable that the gateway device 10 performs only relay processing for communication data of general control in at least one of a layer 2 or layer 3, or the like.

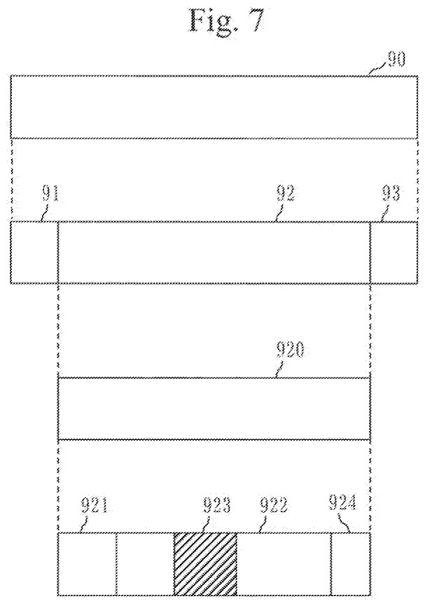

FIG. 7 is a figure describing a communication packet corresponding to each of the communication method 1 and the communication method 2. The structure of the communication packet is the same as that in general safety communication.

A general communication packet 90 is composed of a general communication header 91, a general communication payload 92, and a general communication frame check sequence (FCS) 93. A safety communication packet 920 is stored as at least part of the general communication payload 92.

The safety communication packet 920 is stored in the general communication packet 90, and is composed of a safety communication header 921, a safety communication payload 922, and a safety communication FCS 924. The safety communication packet 920 is also called a safety packet.

The safety communication header 921 includes information for detecting a communication error such as a destination error during transmission or a timeliness error of the safety communication packet 920, and so on. A timeliness error is, as an specific example, a loss or an unacceptable delay.

The safety communication payload 922 is the body of safety data and includes safety input/output data 923 and so on.

The safety communication FCS 924 is for checking the integrity of the safety communication packet 920, and stores a checksum generated by a cyclic redundancy check (CRC) or the like, for example.

The structure of the communication packet may be defined individually for each of the communication method 1 and the communication method 2, and the structure for the communication method 1 and the structure for the communication method 2 may be different from each other. The safety communication packet 920 conforming to the communication method 1 will be called a safety communication packet P1. The safety communication packet 920 conforming to the communication method 2 will be called a safety communication packet P2.

The internal structure of the communication packet may be different from the structure described above. As a specific example, the structure of the communication packet may be any of the structures indicated below.

Structure 1: A structure such that the safety communication packet 920 is transmitted through a transmission path without being stored in the general communication packet 90.

Structure 2. A structure such that the safety communication header 921 and the safety communication FCS 924 are integrated and stored in the safety communication packet 920.

Structure 3: A structure such that at least one of the safety communication header 921, the safety communication payload 922, and the safety communication FCS 924 is duplicated and stored in the safety communication packet 920, or is divided and stored in the safety communication packet 920.

***Description of Operation***

A procedure for operation of the gateway device 10 is equivalent to a gateway control method. A program that realizes the operation of the gateway device 10 is equivalent to the gateway control program. A procedure for operation of the engineering tool 30 is equivalent to an engineering method. A program that realizes the operation of the engineering tool 30 is equivalent to the engineering program.

The operation of the safety control system 80 is composed of a setting phase and a control phase.

In the setting phase, the user programs necessary control logic using the engineering tool 30, and the engineering tool 30 sets a program and parameters generated as a result in the safety controller 20 and the gateway device 10.

In the control phase, the safety controller 20 and the gateway device 10 perform safety control in corporation with the safety input/output unit 40 based on the program and parameters that have been set.

<Control Phase>

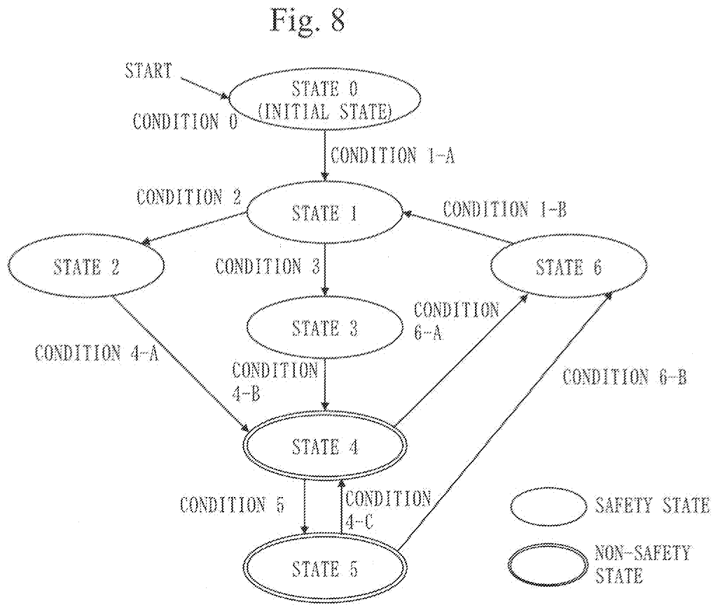

FIG. 8 illustrates an example of one set of control logic that is set in the safety control system 80. In the following, the operation of the safety control system 80 in a case where gateway logic in accordance with this control logic is set will be described. In the safety control system 80, a plurality of sets of control logic that are mutually different may be set in parallel. The safety control system 80 can handle the case where a plurality of sets of control logic are set in parallel by applying a specific example for one set of control logic to be described below to each of the plurality of sets of control logic. With regard to a case where a plurality of safety control programs operate in cooperation in the safety control system 80, the safety control system 80 can handle the case by the method described below because outputs from other safety control programs are only added to conditions for state transition.

The control logic indicated in FIG. 8 has seven states from state 0 to state 6, and has 11 state transitions. Among these, the non-safety state is only state 4 and state 5 and the rest of the states are the safety state. The non-safety state is, as a specific example, a state indicating that the connected device is allowed to operate. The safety state is, as a specific example, a state indicating that the connected device is to be stopped. In the safety state, the safety control system 80 performs safety control.

In order for the safety control system 80 to perform the control indicated in FIG. 8, the safety control system 80 needs to be able to recognize the following recognition item 1 and recognition item 2. A management-target non-safety state is a state, among the non-safety state, that is managed so as to be distinguished from the safety state. The management-target non-safety state is substantially the same as a management-target safety state to be described later.

Recognition item 1: The control state is state 4 or state 5, which is the management-target non-safety state.

Recognition item 2: Condition 6-A or condition 6-B, which is a condition for transition from the non-safety state to the safety state, is satisfied.

It is conceivable that the safety control system 80 is configured to consider only the recognition item 2. However, if at least one of condition 6-A and condition 6-B is a duplicate of another transition condition, an unnecessary output may be made even though the safety state is already realized. If an unnecessary output is made, an output indicating the safety state will be made, so that there is no risk that control will unintentionally deviate from the safety state, but there is a risk that the unnecessary output will cause the operation of the control application to be unstable, resulting in occurrence of an error. Therefore, for the operation of the safety control system 80, it is necessary to confirm whether both the recognition item 1 and the recognition item 2 can be recognized in the safety control system 80.

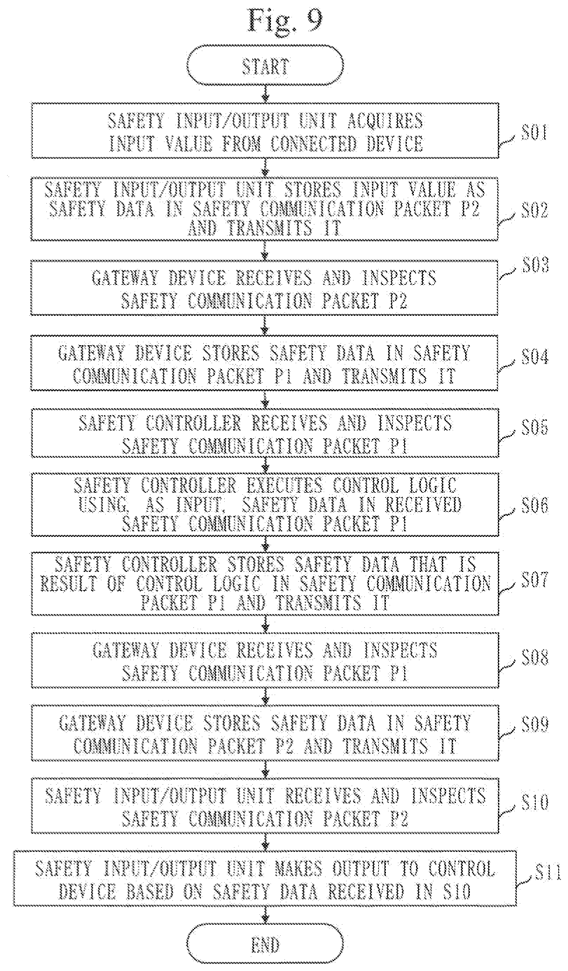

FIG. 9 is a flowchart illustrating an example of an overall flow of the basic operation of the safety control system 80. Referring to this figure, the basic operation of the safety control system 80 will be described.

A sequence of processing of the control application will be described. First, the safety input/output unit 40 outputs, to the safety controller 20, safety data indicating data obtained from the connected device. Then, the safety controller 20 decides control of the safety input/output unit 40 using the safety data input via the gateway device 10, and outputs safety data indicating a decided result to the safety input/output unit 40. Then, the safety input/output unit 40 outputs, to the control device, data based on the safety data input via the gateway device 10. The control application is realized by repeating this sequence of processing.

As a preliminary explanation, the basic operation from input to output will be described, except for portions corresponding to characteristic differences between the existing technique and this embodiment. In the following, the operation of the safety control system 80 is described, focusing on one flow from acquirement of data from the connected device by the safety input/output unit 40 to output of data to the control device by the safety input/output unit 40. However, in the safety control system 80, operation may be realized such that the safety input/output unit 40, the gateway device 10, and the safety controller 20 operate asynchronously, and data acquired by the safety input/output unit 40 as a result is processed in a bucket-brigade manner. In each of the safety input/output unit 40, the gateway device 10, and the safety controller 20, internal processing such as generation or inspection of the safety communication packet P2 or execution of control logic may each be operated with independent timing.

(Step S01)

The safety input/output unit 40 acquires an input value by reading out a signal, an electric potential, or the like from the connected device connected under the safety input/output unit 40. The input value may be a bit value or a multi-bit value like an analog value. The timing to acquire the input value may be any timing, and is, as a specific example, timing according to a predetermined cycle or timing in response to a request from the safety controller 20 or the gateway device 10.

(Step S02)

The safety input/output unit 40 stores data indicating the input value as safety data in the safety communication packet P2, and transmits the safety communication packet P2 to the gateway device 10 via the network N2. The timing for the safety input/output unit 40 to transmit the safety communication packet P2 is generally the same timing as the timing in step S01, but may be different from the timing in step S01.

In this step and all subsequent steps, processing related to generation, transmission, or inspection of the safety communication packet 920 is realized in a safety layer. The safety layer is software realized based on functional safety standards such as the International Electrotechnical Commission (IEC) 61508 and the like.

(Step S03)

The gateway device 10 receives the safety communication packet P2, and inspects the received safety communication packet P2. Before retrieving and using the safety data contained in the safety communication packet P2, the gateway device 10 checks, by inspection, whether a communication error has occurred in relation to the safety communication packet P2.

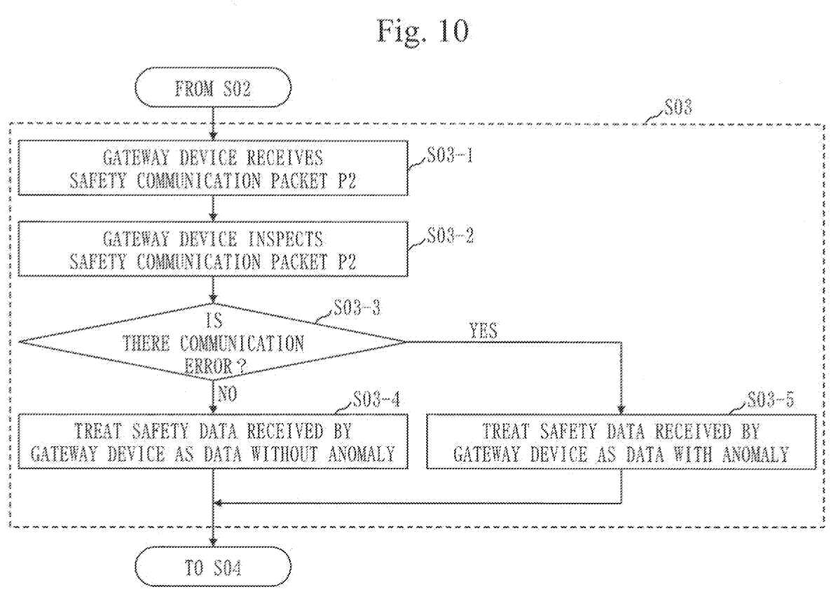

FIG. 10 is a flowchart illustrating an example of a detailed flow of this step. Referring to this figure, the flow will be described.

(Step S03-1)

The gateway device 10 receives the safety communication packet P2 from the network N2, using the second communication port 112.

(Step S03-2)

The gateway device 10 inspects whether a communication error has occurred in the received safety communication packet P2 by checking the content of each of the safety communication header 921 and the safety communication FCS 924 contained in the safety communication packet P2. As a specific example, the gateway device 10 inspects the safety communication packet P2 by combining checking methods such as that the value of each field of the safety communication header 921 is a value within a range expected as the proper safety communication packet P2, and that a check sum of the entire safety communication packet P2 including the safety communication FCS 924 is calculated by a CRC operation using a specified initial value and polynomial and a result of the calculation is a normal value. The method for inspecting the safety communication packet P2 may be different for each safety communication method.

(Step S03-3)

If no communication error has occurred in the received safety communication packet P2, the gateway device 10 proceeds to step S03-4. Otherwise, the gateway device 10 proceeds to step S03-5.

(Step S03-4)

The gateway device 10 treats the safety data contained in the received safety communication packet P2 as the safety data with no anomaly. Specifically, in the next step, the gateway device 10 trusts the safety data and does not make an error output or the like when inputting the safety data to the control logic and outputting an output from the control logic to the safety input/output unit 40.

(Step S03-5)

The gateway device 10 treats the safety data contained in the received safety communication packet P2 as the safety data with an anomaly. Specifically, the gateway device 10 does not use the safety data for making an input to the control logic and outputting an output by the control logic to the safety input/output unit 40. In order to realize the processing of this step, methods that are generally used include discarding the safety data without passing it to any subsequent step, setting a flag to represent a communication error in the communication packet so as to prevent the safety data from being used for control, and using the communication error as a trigger to forcibly disconnect the connection in the immediately following network.

The reception and inspection of the safety communication packet P2 are generally performed at the same frequency as that of the transmission of the safety communication packet P2 in step S02, but may be performed at a frequency different from this frequency.

The subsequent flow related to the reception and inspection of the safety communication packet 920 is substantially the same as the flow of step S03-1 to step S03-5, although the subject of operation and the communication method of the safety communication packet 920 that is handled may be different. The subsequent flow related to the reception and inspection of the safety communication packet 920 will be described below.

(Step S05)

The safety controller 20 performs substantially the same flow as the flow from step S03-1 to step S03-5 for the safety communication packet P1 received from the gateway device 10.

(Step S08)

The gateway device 10 performs substantially the same flow as the flow from step S03-1 to step S03-5 for the safety communication packet P1 received from the safety controller 20.

(Step S10)

The safety input/output unit 40 performs substantially the same flow as the flow from step S03-1 to step S03-5 for the safety communication packet P2 received from the gateway device 10.

(Step S04)

The gateway device 10 stores safety data in the safety communication packet P1, and transmits the safety communication packet P1 to the network N1. The safety data stored here is the safety data obtained as a result of performing step S03.

If a communication error has been detected in step S03, the gateway device 10 makes it possible to notify the safety controller 20 of occurrence of the communication error by, as a specific example, storing safety data indicating a non-steady state in the safety communication packet P1 to be transmitted, setting a flag to represent the communication error in the safety communication packet P1. disconnecting the safety connection, and so on.

(Step S05)

The safety controller 20 receives the safety communication packet P1 from the gateway device 10 via the network N1, and inspects the received safety communication packet P1. At this time, the safety controller 20 performs substantially the same processing as the processing by the gateway device 10 in step S03.

If the safety controller 20 has detected a communication error, the safety controller 20 will not use, as normal safety data, the safety data contained in the received safety communication packet P1 for the control logic.

(Step S06)

The safety controller 20 executes the control logic using, as input, the safety data contained in the received safety communication packet P1. The control logic is configured to execute a program to control the safety input/output unit 40 using, as input, safety data generated by the safety input/output unit 40, and to output a result of executing the program as safety data to the safety input/output unit 40. The control logic includes processing to control the safety control system 80 so that the state of the safety control system 80 becomes the safety state when, for example, a communication error is detected due to detection of a non-steady state indicated in the input safety data, setting of the flag to represent a communication error in the safety communication packet P1, or occurrence of disconnection of the safety connection.

(Step S07)

The safety controller 20 stores safety data indicating a result of executing the control logic in the safety communication packet P1, and transmits the safety communication packet P1 to the network N1.

(Step S08)

The gateway device 10 receives the safety communication packet P1 from the safety controller 20, and inspects the received safety communication packet P1. At this time, the gateway device 10 performs substantially the same processing as the processing by the gateway device 10 in step S03. If the gateway device 10 has detected a communication error, the gateway device 10 will not use the safety data contained in the safety communication packet P1 for the control logic as normal data.

(Step S09)

The gateway device 10 stores the safety data contained in the safety communication packet P1 in the safety communication packet P2, and transmits the safety communication packet P2 to the network N2.

(Step S10)

The safety input/output unit 40 receives the safety communication packet P2, and inspects the received safety communication packet P2. At this time, the safety input/output unit 40 performs substantially the same processing as the processing by the gateway device 10 in step S03.

(Step S11)

The safety input/output unit 40 outputs an output value corresponding to the safety data contained in the safety communication packet P2 received in step S10 to the control device connected under the safety input/output unit 40. The safety input/output unit 40 may perform the output via a connection terminal included in the safety input/output unit 40. The method for output may be substantially the same as the method for output adopted by a commonly used safety input/output unit. As a specific example, the safety input/output unit 40 performs the output using an output of a PNP transistor or the like.

If the safety input/output unit 40 has detected a communication error in step S10 and if the parameter or the like related to the communication error is not within a preset allowable range, the safety input/output unit 40 outputs a predetermined value corresponding to the safety state so as to transition the control state to the safety state, as a specific example. The allowable range is, as a specific example, a range of at least one of the number of times and a time period. It is common to adopt a method of determining whether the parameter or the like related to communication errors is within the allowable range based on whether the number of normal safety communication packets received by the safety input/output unit within a preset watchdog time period is equal to or greater than a predetermined value. However, the safety input/output unit may determine whether occurrence of communication errors is within the allowable range by other methods.

The above is the basic operation from input to output of the safety control system 80 including the gateway device 10, excluding the characteristics of this embodiment. Differences between the above basic operation and characteristic operation according to this embodiment will be described below.

In this embodiment, step S04 is changed to step S04′, and in step S04′ the gateway device 10 performs control corresponding to the safety data received from the safety input/output unit 40, making it possible to realize high response performance.

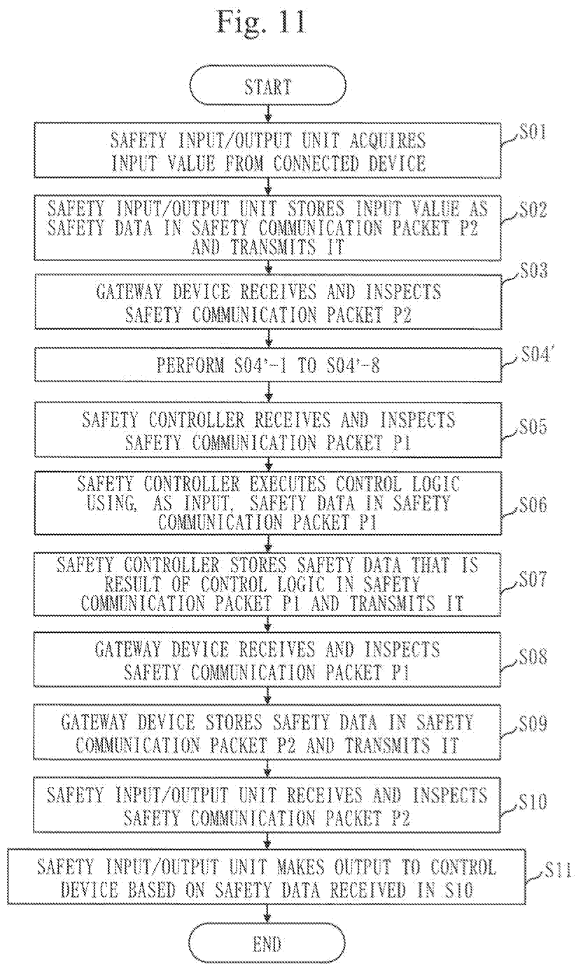

FIG. 11 is a flowchart illustrating an example of an overall flow of the operation of the safety control system 80. Referring to this figure, the characteristic operation of the safety control system 80 will be described.

(Step S04′)

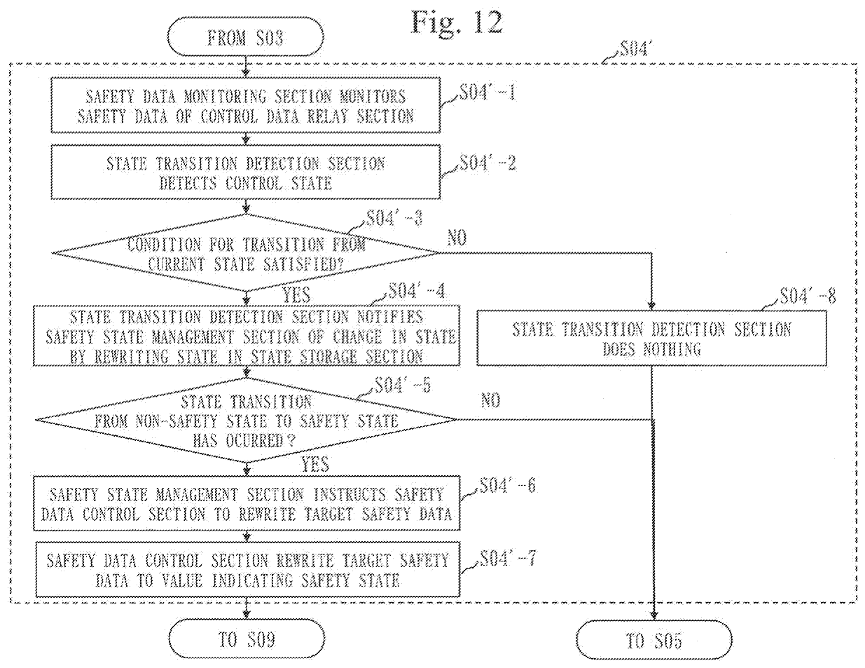

FIG. 12 is a flowchart illustrating an example of a detailed flow of step S04′. Referring to this figure, the flow will be described.

(Step S04′-1)

The safety data monitoring section 132 monitors, as monitoring safety data, safety data relayed by the control data relay section 114. The monitoring safety data in step S04′ is safety data that the gateway device 10 relays from the safety input/output unit 40 to the safety controller 20. The monitoring safety data is stored in part of a memory area managed by the control data relay section 114, and the state monitoring control section 130 cannot know a method for accessing the monitoring safety data without information indicating this method. Therefore, a safety data mapping table 194 is prepared that indicates identification information of the monitoring safety data in association with information on a memory address or the like for accessing the monitoring safety data. A memory address may be written as an address.

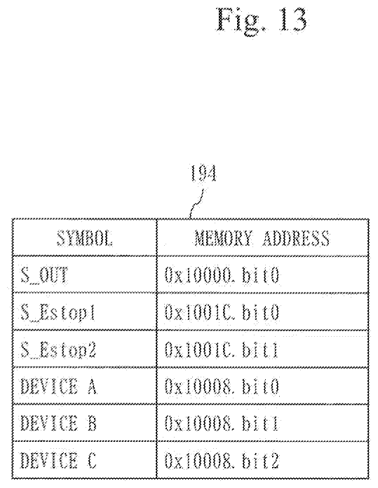

FIG. 13 illustrates a specific example of the safety data mapping table 194 in a table format. A symbol is information that identifies data, and is the name or the like of the data. If the safety data mapping table 194 is as indicated in this example and, as a specific example, if safety data named S_Estop1 needs to be monitored as monitoring safety data, the safety data monitoring section 132 obtains the value of S_Estop1 by referring to the safety data mapping table 194 so as to obtain information that the monitoring safety data is indicated in bit 0 at memory address 0x1001C and accessing this memory address.

(Step S04′-2)

The state transition detection section 131 detects which state among the states indicated in a state transition table 192 the control state is in, based on the monitoring safety data. The state transition detection section 131 is also called a state comparison detection section. The state transition table 192 is configured so as to, at least, allow the control application to know whether the control state is the non-safety state, and also if the control application can indicate one of a plurality of mutually different non-safety states as the control state, to allow the control application to know the control state is in which one of the plurality of non-safety states. In addition, a state transition table 192 is configured so as to allow the control application to know whether it is the management-target safety state, and also if the control application can indicate a plurality of mutually different management-target safety states, to allow the control application to know which one of the plurality of management-target safety states is the state concerned. The management-target safety state is a state, out of the safety state, to be managed so as to be distinguished from the non-safety state. The non-safety state and the management-target safety state will be collectively called a management-target state.

A specific example of the management-target safety state will be described using FIG. 8. First, it is assumed that the state transition detection section 131 cannot distinguish between state 2 and state 4 only by statically checking data of the control data relay section 114. In this case, if the current state is state 4, it will transition to state 6 when condition 6-A is satisfied. If the current state is state 2, no state transition will occur even when condition 6-A is satisfied. Therefore, the state transition detection section 131 needs to distinguish between state 2 and state 4, and needs to monitor state 2 as the management-target safety state in order to distinguish between state 2 and state 4. In addition, when it is assumed that state 1 and state 2 cannot be distinguished, the state transition detection section 131 also needs to monitor state 1 as the management-target safety state in order to monitor state 2. On the other hand, although state 3 is a state that can transition to the non-safety state, when it is assumed that the state transition detection section 131 can distinguish between state 4 and state 3 and between state 5 and state 3 only by statically checking data of the control data relay section 114, there is no need to monitor state 3. Therefore, in this case, state 3 is not included in the management-target safety states.

The state transition table 192 indicates at least a current state indicating the control state at a certain time, an output value in the current state, a next state that can be taken in the current state, and a condition for transition from the current state to the next state. The next state is the state next to the current state. The output value is the value of safety data that the safety controller 20 outputs toward the safety input/output unit 40, and is, as a specific example, a binary value that can take 0 or 1 or an analog value expressing a continuous value as a discrete value. The condition for transition is the condition to be taken by the safety data in order to cause a transition to the next state, and is, as a specific example, a condition that is a combination of at least one of that the output value is a specific value, that a rising edge or falling edge of the output value is a specific value, that the output value is above or below a threshold value, and that a change in the output value satisfies a certain criterion, such as that a difference between the current output value and the previous output value exceeds a threshold value. The condition for transition is not limited to a condition for one piece of safety data, and may be a condition that is a combination of conditions respectively corresponding to a plurality of pieces of safety data and may be expressed by a logical sum, logical product, or the like of a plurality of conditions. The state transition table 192 is equivalent to the state transition information, and is equivalent to information indicating at least part of the partial control logic.

The state transition detection section 131 records the current state of the control state in a state storage section 193. The state storage section 193 can distinguish and store at least whether the current state corresponds to any of the management-target states. The state storage section 193 may have, in addition to information indicating the current state of the control state, a state change bit representing whether the current state has changed from the immediately preceding control state.

(Step S04′-3)

The state transition detection section 131 refers to the state transition table 192 to determine whether any of conditions for transition corresponding to the current state is satisfied, based on monitoring safety data, repeatedly at least at every timing when a change occurs in the monitoring safety data.

If one of the conditions for transition is satisfied, the gateway device 10 proceeds to step S04′-4. Otherwise, the gateway device 10 proceeds to step S04′-8.

(Step S04′-4)

The state transition detection section 131 overwrites the current state indicated by the state storage section 193 to a state indicated by the next state corresponding to the satisfied condition for transition.

When the control state stored in the state storage section 193 has changed due to operation of the state transition detection section 131, the safety control section 120 performs control to change the value of safety data and the output path of safety data in order to appropriately perform control to transition the state of the safety input/output unit 40 to the safety state or control to release the state of the safety input/output unit 40 from the safety state to the non-safety state. Specifically, the safety control section 120 performs the following processing.

(Step S04′-5)

The safety state management section 121 refers to the state storage section 193 to check whether the control state has changed from the state at the last check. The safety state management section 121 is also called a safety state activation management section. The safety state management section 121 may use the state change bit in the state storage section 193 to check whether the control state has changed. If the control state has changed, the safety state management section 121 retrieves the changed control state from the state storage section 193, and refers to an entry in the state transition table 192 corresponding to the retrieved control state.

If the control state has changed from the non-safety state to the safety state, the gateway device 10 proceeds to step S04′-6. Otherwise, the gateway device 10 proceeds to step S05.

(Step S04′-6)

In order to allow safety control to be performed at relatively high speed in the safety control system 80, the gateway device 10 rewrites target safety data to an unsteady value, and outputs the target safety data whose value has been rewritten to the safety input/output unit 40. The target safety data is safety data that is managed by the control data relay section 114 and is output to the safety input/output unit 40 after being rewritten by the gateway device 10. The target safety data may be safety data output by the safety controller 20, or may be data indicating a default value when no safety data has been received from the safety controller 20. The default value indicates an unsteady state, and is a value that does not cause any problem in the safety input/output unit 40 even when it is input to the safety input/output unit 40. The safety input/output unit 40 can treat the received target safety data in substantially the same way as safety data output by the safety controller 20. The rewritten target safety data may be written simply as the target safety data. As a specific example, the gateway device 10 outputs the target safety data to the safety input/output unit 40 so as to make it appear that the target safety data is relayed from the safety controller 20 to the safety input/output unit 40.

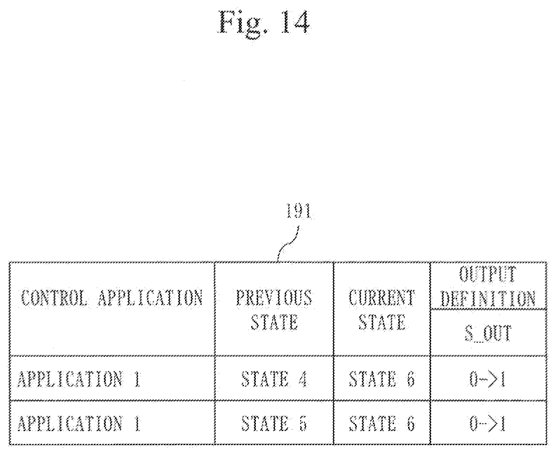

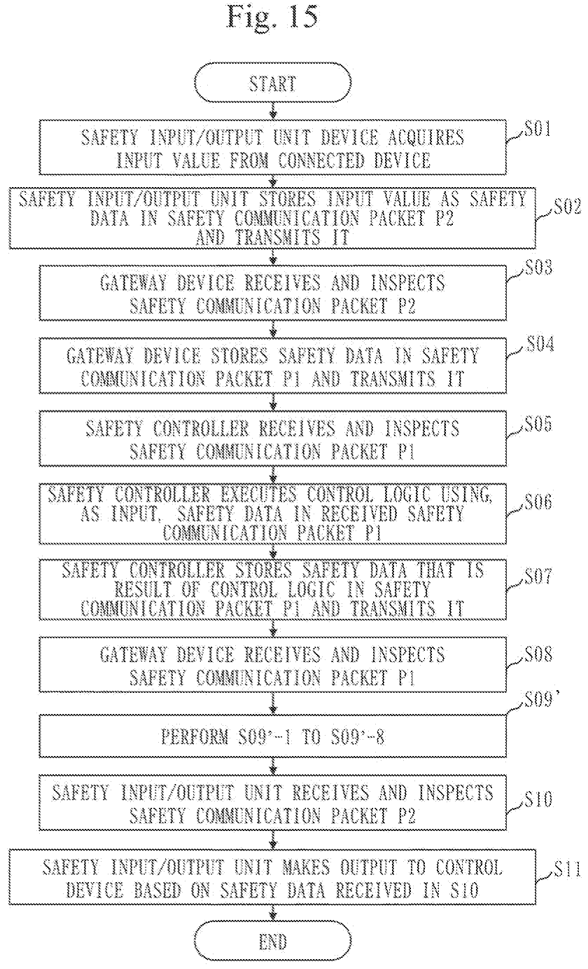

When the control state has changed from the non-safety state to the safety state, the safety state management section 121 determines how to change the target safety data by referring to output definition information 191. The output definition information 191 is also called safety-state output definition information. The output definition information 191 is information including at least a set of three, a previous state, a current state, and an output definition, and indicates a value to be output when the control state changes from the previous state to the current state. The previous state is the state immediately preceding the current state. The output definition is defined so that when the gateway device 10 generates safety data in accordance with the output definition, the generated safety data indicates the safety state. FIG. 14 illustrates a specific example of the output definition information 191. In a “control application” column, the names of control applications are input.

The safety state management section 121 instructs the safety data control section 122 to change the target safety data to safety data in accordance with the output definition.

The safety control section 120 continues to perform the processing of this step and step S04′-7 until cancellation in step S09′ is performed.

(Step S04′-7)

The safety data control section 122 refers to the safety data mapping table 194 to identify the address of the target safety data, as in the processing performed by the safety data monitoring section 132.

Then, the safety data control section 122 rewrites the target safety data corresponding to the identified address in accordance with the output definition. The gateway device 10 outputs the rewritten target safety data to the safety input/output unit 40. As a result, safety control required in the safety control system 80 is performed at relatively high speed.

As to rewriting of the target safety data by the control data relay section 114, management is required so that the target safety data is not rewritten to indicate the non-safety state until the control state transitions from the safety state to the non-safety state due to an output from the safety controller 20 based on the monitoring safety data that has caused the target safety data to be rewritten to indicate the safety state or safety data later than this monitoring safety data. Aa a specific example, a case will be considered where after the safety data control section 122 has overwritten the target safety data to be safety data indicating the safety state based on certain monitoring safety data, the safety controller 20 outputs safety data indicating the non-safety state as a result of control based on safety data older than the certain monitoring safety data. In this case, the gateway device 10 needs to preferentially output the target safety data to the safety input/output unit 40 rather than the safety data received from the safety controller 20. As a specific example of means for this, means that can be pointed out is providing a flag to indicate that the target safety data is locked due to overwriting by the safety data control section 122, and performing control to prevent the target safety data from being updated based on safety data output by the safety controller 20 when the value of the flag is a specific value. Alternatively, means that can be pointed out is protecting the target safety data, such as moving the target safety data to a different buffer area so as to prevent an output from the safety controller 20 from being reflected in the target safety data.

By processing of this step, a control result for the safety data received from the safety input/output unit 40 is reflected in the target safety data that the gateway device outputs to the safety input/output unit 40. The gateway device 10 includes the target safety data in which the control result is reflected in the safety communication packet P2, and transmits it to the safety input/output unit 40. Therefore, after completion of the processing of this step, processing continues from step S09.

(Step S04′-8)

The state transition detection section 131 does not rewrite the current state indicated by the state storage section 193.

The safety control section 120 does nothing, and the gateway device 10 transitions to step S05.

On the other hand, when the control state has transitioned from the safety state to the non-safety state, it is necessary to control switching so that safety data received from the safety controller 20 is preferentially output to the safety input/output unit 40 by means similar to the means described above.

Therefore, the safety state management section 121 determines how to change the safety data when the control state has changed by referring to the output definition information 191. The structure of the output definition information 191 is as described above, but the content stored in the output definition is different.

Therefore, in this embodiment, step S09 is changed to step S09′, and in step S09′ the cancellation of the safety state is detected based on an output from the safety controller 20 and the processing for transitioning to the safety state performed in step S04′ is canceled.

FIG. 15 is a flowchart illustrating an example of an overall flow of the operation of the safety control system 80. Referring to this figure, the characteristic operation of the safety control system 80 will be described.

(Step S09′)

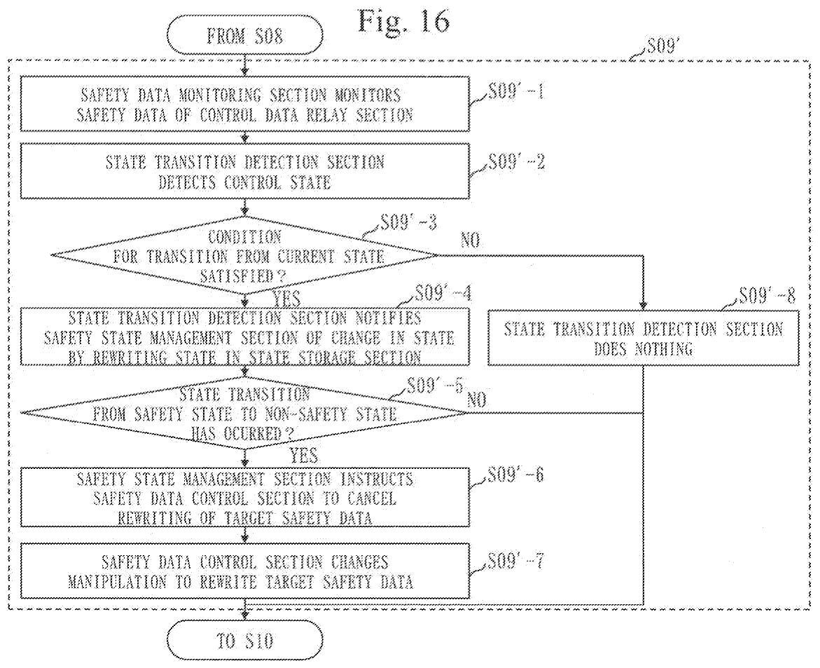

FIG. 16 is a flowchart illustrating an example of a detailed flow of step S09′. Referring to this figure, the flow will be described.

(Step S09′-1)

This step is substantially the same as step S04′-1. However, the monitoring safety data in this step is safety data that the gateway device 10 relays from the safety controller 20 to the safety input/output unit 40.

Step S09′-2 is substantially the same as step S04′-2.

Step S09′-3 is substantially the same as step S04′-3.

Step S09′-4 is substantially the same as step S04′-4.

Step S09′-5 is substantially the same as step S04′-5. If the control state has not changed from the safety state, the safety state management section 121 does nothing and transitions to step S11.

(Step S09′-6)

The safety state management section 121 requests the safety data control section 122 to cancel rewriting of the target safety data. That is, in this step, processing is performed that is the reverse of rewriting of the target safety data that the safety state management section 121 performs for the safety data control section 122 in step S04′-6, so as to cause the safety data output by the safety controller 20 to be output to the safety input/output unit 40 instead of the target safety data.

When the control state has changed from the safety state to the non-safety state, the safety state management section 121 determines how to change the target safety data by referring to the output definition information 191. The output definition information 191 includes, as an output definition, information indicating safety data to be manipulated and a method for manipulating the safety data when the control state has transitioned from the safety state to the non-safety state. As a specific example, this method includes a manipulation to terminate rewriting of the target safety data performed by the safety state management section 121 in step S04′-6.

The safety state management section 121 instructs the safety data control section 122 to reflect the output in accordance with the output definition in the target safety data.

However, it is conceivable that before cancelling overwriting of the target safety data in this step, the safety control section 120 additionally confirms that a transition from the non-safety state to the safety state has not occurred in the control state, and cancels overwriting of safety data only if this transition has not occurred. This is because the time from when the safety input/output unit 40 outputs safety data to when the safety controller 20 outputs a result of executing the control logic based on this safety data includes a delay due to a long communication path or the like. This is because, at the time point when the safety controller 20 outputs safety data indicating a transition to the non-safety state, more recent safety data output by the safety input/output unit 40 may have changed to the content that causes a transition to the safety state. In this case, if the safety control section 120 cancels overwriting of the target safety data, there is a risk that a transition to the non-safety state is prioritized, preventing a transition to the safety state and extending the safety response time.

(Step S09′-7)

The safety data control section 122 changes the manipulation to rewrite safety data by the control data relay section 114. The safety data control section 122 refers to the safety data mapping table 194 to identify the address of the target safety data by substantially the same method as the method performed by the safety data monitoring section 132 in step S04′-7.

The safety data control section 122 then manipulates the target safety data using the identified address of the target safety data. This manipulation depends on the content of the output definition, and causes rewriting of the target safety data performed in step S04′-7 to be terminated so that safety data output by the safety controller 20 is output preferentially. The method for realizing this manipulation may be any method. As a specific example, if overwriting of safety data by the safety data control section 122 is realized by providing the flag to indicate that the target safety data is locked in step S04′-7, this method is restoring the value of the flag to the original value. Alternatively, if means of moving the target safety data to a different buffer area to prevent an output by the safety controller 20 from being reflected in the target safety data is performed in step S04′-7, a method of restoring the state of the buffer area to the original state may be considered.

(Step S09′-8)

If the control state stored in the state storage section 193 has not been changed by operation of the state transition detection section 131, the safety control section 120 does nothing and transitions to step S11.

The operation of the safety control system 80 is as described above. Due to the presence of step S04′ and step S09′, which are the characteristics of this embodiment, the flow from input of safety data to response is as described below.

Case 1: A case where the value of safety data input to the gateway device 10 continues to indicate a steady state or a non-steady state The flow from acquirement of an input value to output is the same as that of the basic operation. Therefore, the safety response time according to this embodiment is the same as the safety response time according to the basic operation. The steady state means that the value of safety data is a value indicating the safety state, and the non-steady state means that the value of safety data is a value indicating the non-safety state.

Case 2: A case where the value of safety data input to the gateway device 10 has changed from the steady state to the non-steady state

The safety control system 80 skips steps from step S05 to step S08 due to the changed step S04′, and starts, from step S09, output of safety data to cause a transition to the safety state to the safety input/output unit 40. Therefore, the safety response time according to this embodiment is improved in comparison with the safety response time according to the basic operation.

Case 3: A case where the value of safety data input to the gateway device 10 has changed from the non-steady state to the steady state The safety state is canceled by the changed step S09′. However, the length of the step is the same as the length of the step in the basic operation, so that the safety response time according to this embodiment is the same as the safety response time according to the basic operation.

In the above three cases, the safety response time that is important for ensuring safety and whose performance is required to be guaranteed in the functional safety standards is the worst time in case 2. On the other hand, the safety response time in each of case 1 and case 3 may lead to improvement of productivity, but does not lead to ensuring safety. In this embodiment, the safety response time for ensuring safety can be shortened by relatively simple processing by the gateway device 10.

Settings by the engineering tool 30 to realize the control phase will be described below.

In this embodiment, it is necessary to set the output definition information 191, the state transition table 192, the state storage section 193, and the safety data mapping table 194 in the gateway device 10. Specific pieces of data of these pieces of data vary depending on the control application to be realized. Although it is conceivable to set these manually by the user, it is realistic to set these in the gateway device 10 by an engineering tool in order to reduce man-hours for setting work.

A specific example of setting work that uses the engineering tool 30 and is linked to programming by the user will be described. Among the constituent elements of the engineering tool 30, parts characteristic of this embodiment, as opposed to a general engineering tool, are the gateway logic generation section 32 and the gateway logic setting section 33.

The programming means provision section 31 provides the user with means of creating a program to be executed by the safety controller 20 and means of setting necessary parameters.

As a specific example, the programming means provision section 31 may provide commonly-used constituent elements of programs as function blocks in advance, and the user may create a program to configure required control logic by combining the provided function blocks, basic operations such as logical sum (OR), product (AND), negation (NOT), and exclusive logical sum (XOR), and other uniquely created function blocks or the like. The program may be a program that conforms to a programming method and language used in the field of factory automation, such as one using procedural programing or ladder logic. Since the programming means provision section 31 is a constituent element that handles safety programs, it typically needs to be realized in accordance with safety standards such as the IEC 61508 series of functional safety.

The logic generation section 34 generates logic and parameters to be assigned to the safety controller 20 according to a result of the programming means provision section 31. The logic is a file to execute programmed control logic. The logic and parameters are protected using CRC or the like to prevent data corruption leading to malfunction of the safety control system 80.

The logic setting section 35 transmits the logic and parameters generated by the logic generation section 34 to the safety controller 20. The safety controller 20 writes the received logic and parameters. As means of transmission, means using USB, a local area network (LAN), or the like may be pointed out, but any means may be used as long as the purpose of allowing the logic setting section 35 to transmit the logic and parameters to the safety controller 20 and allowing the safety controller 20 to write the received logic and parameters can be achieved.

The gateway logic generation section 32 performs the following based on the program and parameters input to the engineering tool 30 by the programming means provision section 31. The following will be described assuming that the program is realized by a combination of general-purpose function blocks.

<Generation of the State Transition Table 192>

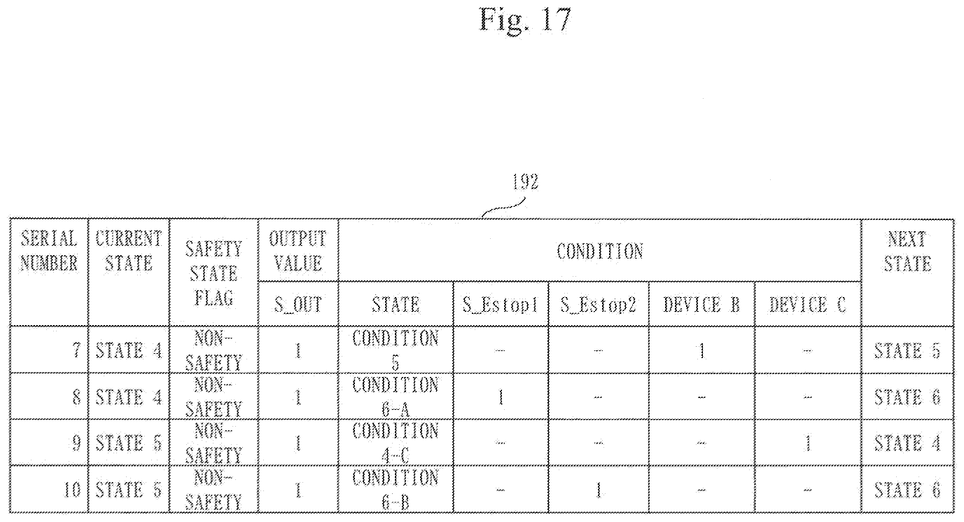

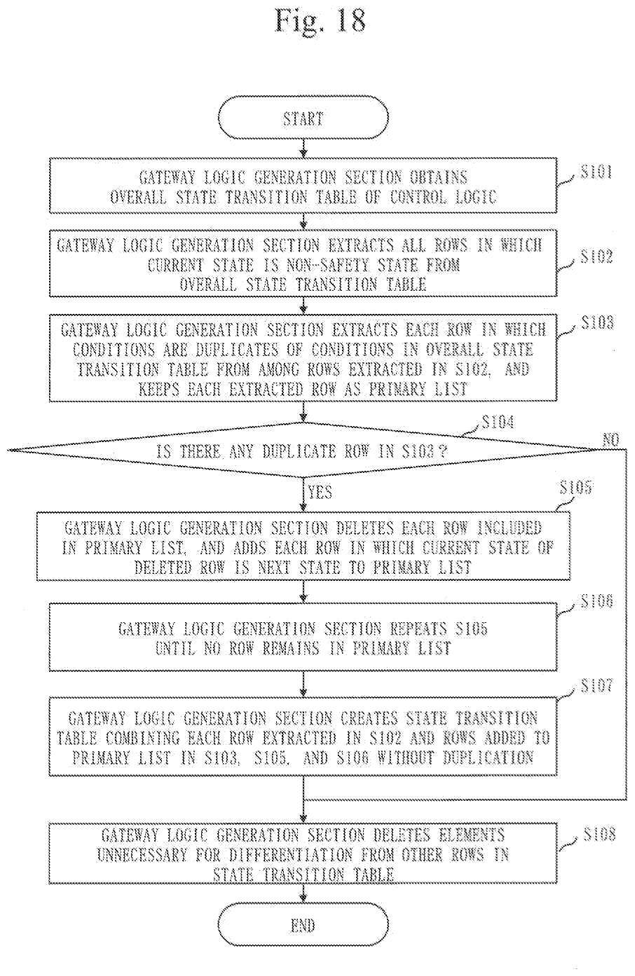

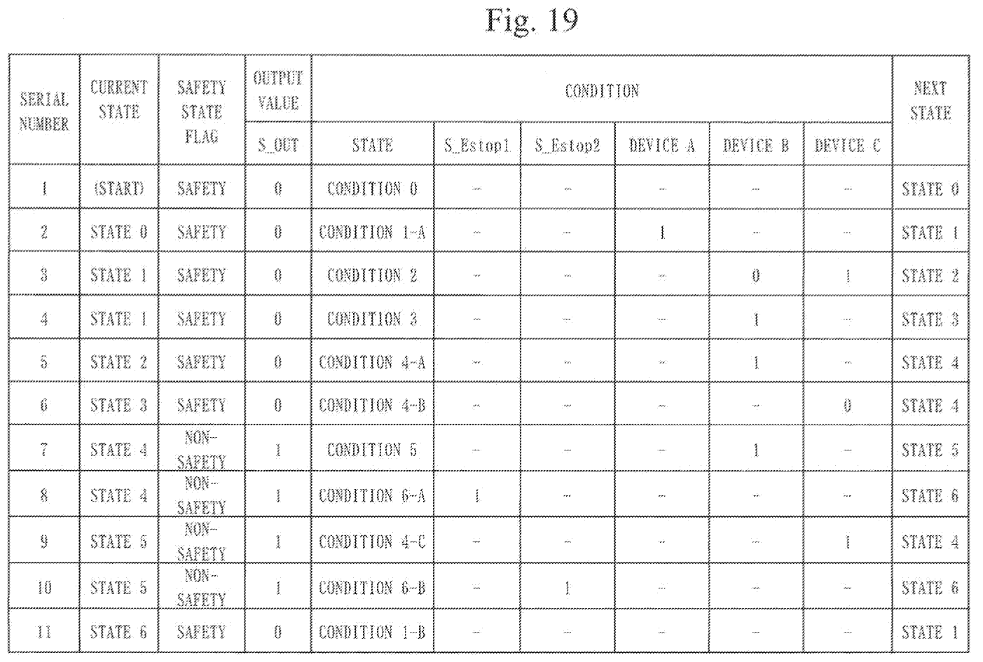

The gateway logic generation section 32 creates the state transition table 192 based on the program set in the programming means provision section 31. FIG. 17 illustrates a specific example of the state transition table 192 corresponding to an overall state transition table indicated in FIG. 19. Each column from “S_Estop1” to “device C” indicates each item of safety data. The state transition table 192 is arranged by extracting information from information equivalent to a program state transition table used in general software design, system design, or the like so as to allow the state transition detection section 131 to make determinations on at least the following condition 1 and condition 2.

Condition 1: The control state is the management-target non-safety state, and a condition for transition to the safety state is satisfied.

Condition 2: The control state has transitioned from the safety state to the non-safety state.

FIG. 18 is a flowchart illustrating an example of processing to obtain part of the state transition table 192 for making a determination on condition 1. Referring to this figure, the processing will be described.

(Step S101)

The gateway logic generation section 32 obtains the overall state transition table of the control logic. The overall state transition table is a state transition table for the entire control logic from which information unnecessary for the state transition table 192 has not been removed.

FIG. 19 illustrates an example of arrangement of the overall state transition table corresponding to FIG. 8. As a method for the gateway logic generation section 32 to obtain the overall state transition table, a method may be considered in which a state transition table for function blocks prepared in advance in the engineering tool 30 is created in a design stage, and the created state transition table is provided as part of the engineering tool 30. The state transition table 192 includes at least information indicating each of identification information representing the current state, a condition to be satisfied for occurrence of a state transition corresponding to the current state, and the next state. The condition is defined so that the value of the device to be satisfied, a change in the value, and the like can be identified. A change in the value is, as a specific example, a change in the value on a rising edge, a change in the value on a falling edge, or a change in the value is above or below a threshold value. The overall state transition table according to this embodiment needs to include the safety state flag to indicate whether the current state is the safety state.

The method for the gateway logic generation section 32 to obtain the overall state transition table is not limited to the method described above. As a specific example, the gateway logic generation section 32 may obtain the overall state transition table by analyzing a program generated by the user, or may obtain the overall state transition table in cooperation with the programming means provision section 31 and various design tools based on design information of the program.

(Step S102)

The gateway logic generation section 32 extracts all rows corresponding to the non-safety state from the overall state transition table. The gateway logic generation section 32 can extract a state corresponding to the non-safety state by referring to the value of “safety state flag”. The gateway logic generation section 32 keeps the rows extracted in this step.

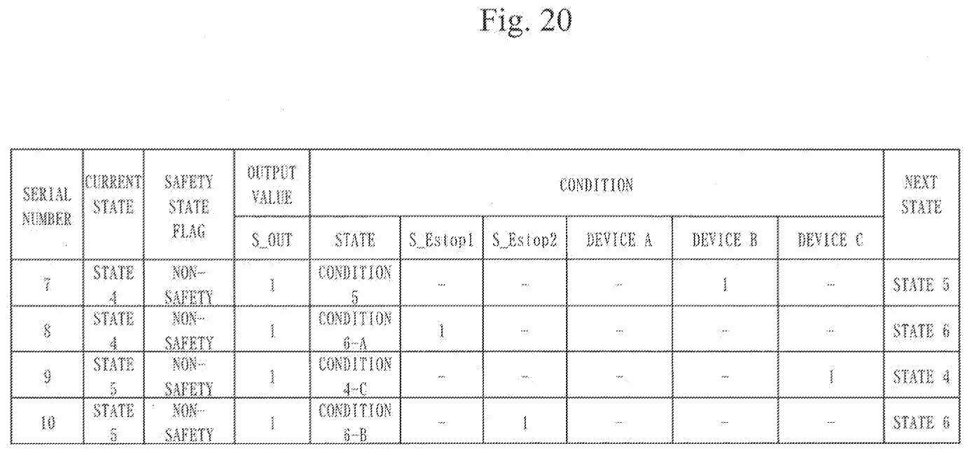

FIG. 20 indicates a result of performing the processing of this step on the example indicated in FIG. 19.

(Step S103)

The gateway logic generation section 32 extracts a duplicate row corresponding to at least one of the other rows in the overall state transition table from among the rows extracted in step S102. A duplicate row is a row in which the values of safety data of “condition” in the row are respectively duplicates of the values of safety data of “condition” in another row. When “conditions” of two rows match completely, the gateway logic generation section 32 determines that these “conditions” are duplicates. The gateway logic generation section 32 keeps each row extracted in this step as a primary list.

In the example indicated in FIG. 20, the values of S_Estop1 to device C, which are the values of safety data, of “condition” of serial number 7 are duplicates of the values of safety data of “condition” of each of serial numbers 4 and 5. Therefore, the row corresponding to serial number 7 is a duplicate row, so that the gateway logic generation section 32 keeps the row corresponding to serial number 7 as the primary list.

(Step S104)

If the gateway logic generation section 32 has extracted any duplicate row in step S103, the gateway logic generation section 32 transitions to step S105. Otherwise, the gateway logic generation section 32 transitions to step S108.

(Step S105)

The gateway logic generation section 32 deletes each row included in the primary list from the primary list, and extracts, from the overall state transition table, a row in which the current state indicated in each deleted row is the next state. The gateway logic generation section 32 adds each row extracted in this step to the primary list and keeps it.

The case will be considered where the row corresponding to serial number 7 is included in the primary list, as described above. In this case, the current state of serial number 7 is state 4, and rows in which state 4 is the next state are rows corresponding to serial numbers 5 and 6. Therefore, the gateway logic generation section 32 adds the rows corresponding to serial numbers 5 and 6 to the primary list.

(Step S106)

The gateway logic generation section 32 deletes, from the primary list, a row in which the values of safety data of “condition” are not duplicates of the values of safety data of “condition” of each row extracted in step S102 and the values of safety data of “condition” of each row that has ever been added to the primary list since start of processing of this flowchart, from among the rows included in the primary list that is a result of performing step S105. If there is a row that remains in the primary list, the gateway logic generation section 32 returns to step S105. The gateway logic generation section 32 repeats step S105 until no row remains in the primary list.

The case will be considered where the rows corresponding to serial numbers 5 and 6 are included in the primary list, as described above. In the row corresponding to serial number 5, the values of safety data of “condition” are duplicates of those in the row corresponding to serial number 4, so that it is not removed from the primary list and is to be processed in step S105. The current state of serial number 5 is state 2, and a row in which the next state is state 2 is only the row corresponding to serial number 3. Therefore, when the gateway logic generation section 32 performs step S105 next time, the row corresponding to serial number 3 is added to the primary list. The values of safety data of “condition” of the row corresponding to serial number 6 are not duplicates of those in any row to be compared with in this step, so that it is removed from the primary list.

(Step S107)

The gateway logic generation section 32 creates a state transition table that combines each row extracted in step S102 and each row that has ever been added to the primary list at least in one of step S103, step S105, and step S106 without duplication.

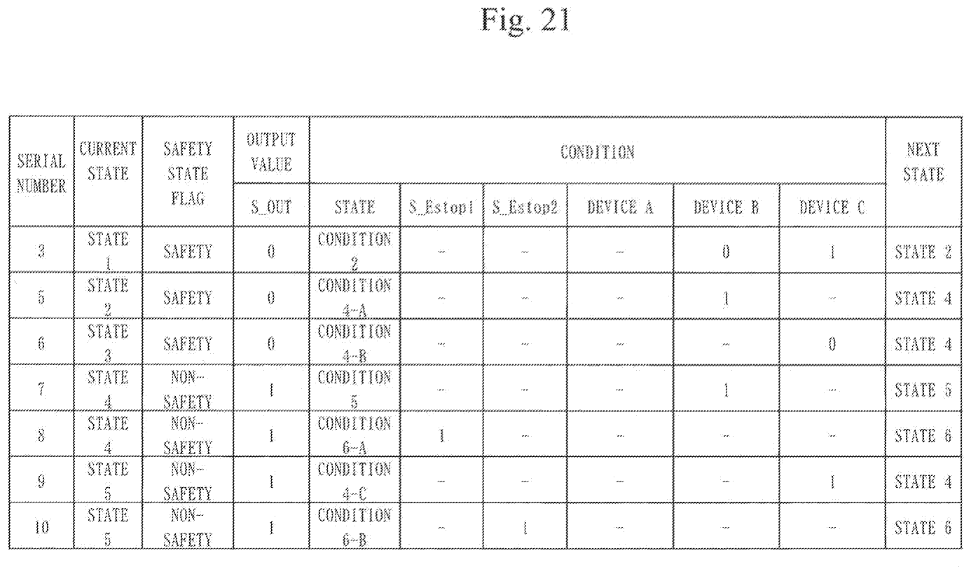

FIG. 21 illustrates a specific example of the state transition table corresponding to FIG. 19 and generated in this step.

(Step S108)

The gateway logic generation section 32 removes, from the state transition table created in step S107, elements that are unnecessary for differentiation from other rows. Although this step is not essential, the gateway logic generation section 32 may perform this step to reduce the size of the state transition table 192.

By the above processing, the gateway logic generation section 32 can generate part in the state transition table 192 for making a determination on condition 1.

Similarly, part in the state transition table 192 for making a determination on condition 2 can be generated by changing step S101 to step S108 as described below.

In step S101, the overall state transition table of the control logic is generated for the values of safety data output by the safety controller 20.

In step S102, the gateway logic generation section 32 extracts all rows corresponding to transitions from the safety state to the non-safety state from the overall state transition table.

In steps S103 to step S108, the gateway logic generation section 32 obtains the state transition table by performing substantially the same as that described above.

<Creation of the Output Definition Information 191>

The gateway logic generation section 32 generates the output definition information 191 based on the state transition table 192 and the overall state transition table.

As a specific example, the gateway logic generation section 32 first extracts a transition that causes a transition to the safety state from among the transitions indicated in the state transition table 192, and treats the “current state” and the “next state” corresponding to the extracted transition in the state transition table 192 as the “previous state” and the “current state” of the output definition information 191, respectively. If there are a plurality of extracted transitions, one row in the output definition information 191 corresponds to one transition. Then, the gateway logic generation section 32 refers to the overall state transition table to obtain a change in the “output value” corresponding to the extracted transition, and inputs information indicating the obtained change in the “output definition” in the output definition information 191. “0->1” in FIG. 14 indicates that the output value in the “previous state” is 0 and the output value in the “current state” is 1. If the gateway device 10 executes a plurality of control applications in parallel, information indicating the output definition information 191 corresponds to which one of the control applications may be provided in the output definition information 191.

<Creation of the State Storage Section 193>

The gateway logic generation section 32 creates the state storage section 193, and initializes the created state storage section 193.

If the gateway device 10 executes a plurality of control applications in parallel, the gateway logic generation section 32 creates the state storage section 193 that is a storage area to store the state of each control application, and initializes the state storage section 193 assuming that the state of each control application is the state immediately after start of each control application.

<Creation of the Safety Data Mapping Table 194>

The gateway logic generation section 32 creates the safety data mapping table 194 by associating the name of safety data and identification information of memory. The name may be a label. The identification information is, as a specific example, an address. The correspondence between the name and the identification information is set by the user through the programming means provision section 31 or generated by automatic setting, and the gateway logic generation section 32 generates the safety data mapping table 194 based on information indicating the correspondence. The elements of the safety data mapping table 194 may be any elements that allow the state monitoring control section 130 and the safety control section 120 to identify the location of safety data. The elements of the safety data mapping table 194 may be changed as appropriate, such as using a symbol name instead of the name of safety data described above and using a device number as the identification information.

In the above description of four pieces of information, the state transition table 192, the output definition information 191, the state storage section 193, and the safety data mapping table 194, transitions from the non-safety state to the safety state have been mainly described. Also for transitions from the safety state to the non-safety state, it is necessary to similarly create four pieces of information. The method for generating information is similar to the case of transitions from the non-safety state to the safety state, but differs in the following points.

The gateway logic generation section 32 adds, to the state transition table 192, each row of the overall state transition table indicating a transition from the safety state to the non-safety state without omission and duplication. At this time, the gateway logic generation section 32 adds conditions by focusing on safety data from the safety controller 20 to the safety input/output unit 40. If a condition that cannot be uniquely identified are included, the gateway logic generation section 32 adds a row of the previous state including the condition to the state transition table, and repeats adding the previous state until the newly added previous state can be distinguished from other rows, based on the same line of thinking as in step S105.

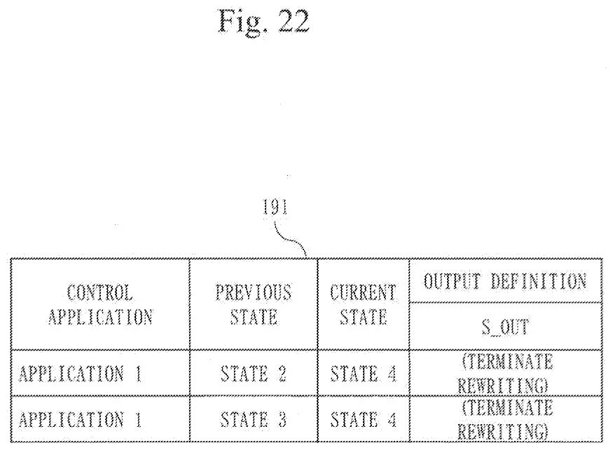

The gateway logic generation section 32 adds the output definition information 191 corresponding to transitions from the safety state to the non-safety state. The “output definition” is created to indicate how to change the manipulation to rewrite safety data described in step S09′-7. FIG. 22 illustrates a specific example of the output definition information 191 concerning transitions from the safety state to the non-safety state. The output definition of this output definition information 191 is information instructing termination of rewriting of safety data, that is, information instructing switching to give priority to an output of the safety controller 20.

### Description of Effects of Embodiment 1

As described above, according to this embodiment, the safety control system 80 in which the safety response time is shortened can be realized at a relatively low cost by using the gateway device 10 that relays communication between the safety input/output unit 40 and the safety controller 20 with a reduced amount of necessary processing. A problem of the background art is that a gateway device that executes control logic with internal states cannot be realized. According to this embodiment, a gateway device that executes control logic with internal states can be realized with a small amount of processing.

Shortening of the safety response time is realized by the capability to perform a transition to the safety state based on a determination by the gateway device 10. Therefore, the safety response time in the existing technique includes a transmission delay and a transmission lag time associated with a round trip from the safety input/output unit 40 to the safety controller 20. According to this embodiment, it is possible to arrange that a transmission delay and a transmission lag time associated with a round trip from the gateway device 10, which is located midway between the safety input/output unit 40 and the safety controller 20, to the safety controller 20 are not included in the safety response time. Since the safety response time is the worst time required for a transition to the safety state, the safety response time can be shortened according to this embodiment. In addition, according to this embodiment, it is possible to configure the gateway device 10 that behaves as if there is no overhead due to conversion of the communication method.

By arranging that the gateway device 10 does not preform processing other than processing related to a transition to the safety state and the gateway device 10 makes a determination on a transition to the safety state according to a determination by the safety controller 20, the processing of the gateway device 10 can be reduced. Therefore, the safety control system 80 can be realized with components such as an inexpensive microcomputer. It is also possible to configure the gateway device 10 that converts more safety connections with limited computational resources, so that the safety control system 80 can be configured at a low cost. In addition, the gateway device 10 can be configured to behave transparently to both the safety controller 20 and the safety input/output unit 40, so that the existing safety controller 20 and the safety input/output unit 40 can be used without modification, which is also a contribution to allow the safety control system 80 to be configured at a low cost.

This embodiment also has similar effects when conversion of a communication method is not required. As a specific example, when the safety control system 80 is configured such that there is a large transmission delay between the safety input/output unit 40 and the safety controller 20, the safety response time can be shortened by installing the gateway device 10 in a location with a small transmission delay such as a location close to the safety input/output unit 40. A system configuration with a large transmission delay between the safety input/output unit 40 and the safety controller 20 is, as a specific example, a configuration in which communication across different network segments occurs using a router, a layer 3 (L3) switch, or the like, a configuration in which the safety controller 20 is installed in a location with a large transmission delay, such as a cloud, or a configuration in which the worst time is long due to poor processing punctuality of the safety controller 20. When the configuration of the safety control system 80 is such a configuration, the gateway device 10 may be configured to communicate with both the safety input/output unit 40 and the safety controller 20 using the same communication method.

When the safety control system 80 is configured in such a way, it is conceivable that it takes time and effort to set gateway logic corresponding to the control logic in the gateway device 10. However, gateway logic can be generated and set semi-automatically with assistance of the engineering tool 30, so that the time and effort associated with this case can be reduced.

The reasons why problems according to Patent Literature 1 occur will now be stated. Patent Literature 1 allows a variation in which the transmission destination of a determination result is changed, so that it is conceivable to realize a gateway device that can avoid occurrence of a transmission delay by performing safety control without waiting for a control output from the safety controller. However, with the scope of disclosure in Patent Literature 1, cases where safety determinations can be made easily are limited, so that a gateway with control logic equivalent to a safety controller is required in order to support a wide range of safety control. Therefore, with the technique of Patent Literature 1, a gateway device cannot be realized at a low cost. Specifically, this is as described below.

Patent Literature 1 describes that the safety determination means can easily determine whether safety conditions are satisfied by logical operations using input safety information, but does not disclose a detailed determination method. However, in many safety control applications, control is performed with internal states, so that safety determinations cannot be made only by operations using input safety information. As a specific example, even if the input safety information is the same, the safety state may differ depending on whether the input safety information has been generated through a certain procedure. This example applies to control such as an emergency stop button, a two-hand control system, and muting.

Similarly, also when a determination result is revised from the safety state to the non-safety state, it is necessary to check whether a predetermined procedure, such as a reset, has been performed, but the technique disclosed in Patent Literature 1 cannot handle a procedure check or the like.

Therefore, since it is not possible to make appropriate safety determinations in a gateway device only by using the existing technique, there is no choice but to additionally adopt one of a method of realizing a safety determination section with the same level of complexity as that of a safety controller in the gateway device and a method of allowing the safety determination section of the gateway device to cause an unnecessary transition to the safety state, instead of reducing the complexity of the safety determination section, for example. It is generally expected that the gateway device is realized at a lower cost in comparison with the safety controller.

Furthermore, the gateway device needs to communicate with both the safety controller and the safety input/output unit. Therefore, when the former is adopted, the processing of the gateway device may be short of a sufficient margin. When the latter is adopted, a safer state than usual is always maintained, so that there is no problem from the viewpoint of functional safety, but a problem is that it is not practical because the availability of the safety control system 80 is reduced. However, according to this embodiment, these problems will not occur.

***Other Configurations***

### <Variation 1>

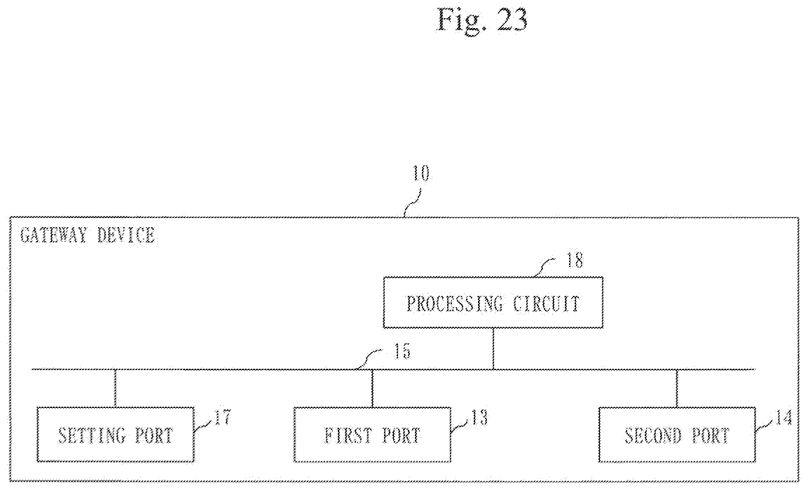

FIG. 23 illustrates an example of a hardware configuration of the gateway device 10 according to this variation.

The gateway device 10 includes a processing circuit 18 in place of the processor 11, in place of the processor 11 and the memory 12, in place of the processor 11 and the non-volatile memory 16, or in place of the processor 11, the memory 12, and the non-volatile memory 16.

The processing circuit 18 is hardware that realizes at least part of the sections included in the gateway device 10.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The gateway device 10 may include a plurality of processing circuits as an alternative to the processing circuit 18. The plurality of processing circuits share the role of the processing circuit 18.

In the gateway device 10, some functions may be realized by dedicated hardware, and the remaining functions may be realized by software or firmware.

As a specific example, the processing circuit 18 is realized by hardware, software, firmware, or a combination of these.

The processor 11, the memory 12, the non-volatile memory 16, and the processing circuit 18 are collectively called “processing circuitry”. That is, the functions of the functional components of the gateway device 10 are realized by the processing circuitry.

Other devices described in this specification may have substantially the same configuration as that of this variation.

### Other Embodiments

Embodiment 1 has been described, and portions of this embodiment may be implemented in combination. Alternatively, this embodiment may be partially implemented. Alternatively, this embodiment may be modified in various ways as necessary, and may be implemented as a whole or partially in any combination.

The embodiment described above is an essentially preferable example, and is not intended to limit the present disclosure as well as the applications and scope of uses of the present disclosure. The procedures described using the flowcharts or the like may be modified as appropriate.

### REFERENCE SIGNS LIST

10: gateway device; 11: processor; 12: memory; 13: first port; 14: second port; 15: bus; 16: non-volatile memory; 17: setting port; 18: processing circuit; 111: first communication port; 112: second communication port; 113: first communication control section; 114: control data relay section; 115: second communication control section; 120: safety control section; 121: safety state management section; 122: safety data control section; 130: state monitoring control section; 131: state transition detection section; 132: safety data monitoring section; 191: output definition information; 192: state transition table; 193: state storage section; 194: safety data mapping table; 20: safety controller; 21: processor; 22: memory; 23: setting port; 24: first port; 25: bus; 26: non-volatile memory; 30: engineering tool; 31: programming means provision section; 32: gateway logic generation section; 33: gateway logic setting section; 34: logic generation section; 35: logic setting section; 40: safety input/output unit; 41: processor; 42: memory; 43: IO port; 44: second port; 45: bus; 46: non-volatile memory; 50: setting terminal; 51: processor; 52: memory; 53: setting port; 55: bus; 56: non-volatile memory; 80: safety control system; 90: general communication packet; 91: general communication header; 92: general communication payload; 93: general communication FCS; 920: safety communication packet; 921: safety communication header; 922: safety communication payload; 923: safety input/output data; 924: safety communication FCS; N1, N2: network; P1. P2: safety communication packet.

1. A gateway device that relays communication of safety data between a safety input/output unit and a safety controller that controls the safety input/output unit so as to establish a safety connection between the safety input/output unit and the safety controller, the safety input/output unit and the safety controller being included in a safety control system, the gateway device comprising
processing circuitry to:
manage a control state that is a state corresponding to a state of the safety control system and is one of a safety state and a non-safety state, and control a state transition of the control state by applying safety data that the gateway device has received from the safety input/output unit to state transition information that indicates a state transition concerning the control state; and
generate, when the control state has transitioned from the non-safety state to the safety state, safety data that indicates the safety state and is to be transmitted to the safety input/output unit.

2. The gateway device according to claim 1,
wherein the processing circuitry disconnects the safety connection when the control state has transitioned from the non-safety state to the safety state.

3. The gateway device according to claim 2,
wherein the processing circuitry controls a state transition of the control state by applying safety data that the gateway device has received from the safety controller to the state transition information, and
wherein while the safety connection is disconnected, the processing circuitry cancels disconnection of the safety connection when the control state has transitioned from the safety state to the non-safety state.

4. The gateway device according to claim 2,
wherein as control to disconnect the safety connection, the processing circuitry performs control to rewrite safety data that the gateway device has received from the safety controller so as to make the safety data indicate the safety state.

5. The gateway device according to claim 2,
wherein while the safety connection is disconnected, the processing circuitry controls a state transition of the control state without using safety data that the gateway device has received from the safety controller, and that indicates a result of performing control based on safety data older than safety data that has caused the safety connection to be disconnected.

6. The gateway device according to claim 1,
wherein the processing circuitry uses partial control logic that is at least part of control logic used by the safety controller, and
wherein the state transition information is information that indicates at least part of the partial control logic.

7. The gateway device according to claim 1,
wherein the state transition information is information that is set using an engineering tool that can communicate with the gateway device.

8. The gateway device according to claim 1,
wherein a communication method adopted by the safety input/output unit is different from a communication method adopted by the safety controller.

9. A gateway control method for controlling a gateway device that relays communication of safety data between a safety input/output unit and a safety controller that controls the safety input/output unit so as to establish a safety connection between the safety input/output unit and the safety controller, the safety input/output unit and the safety controller being included in a safety control system, the gateway control method comprising:
managing a control state that is a state corresponding to a state of the safety control system and is one of a safety state and a non-safety state, and controlling a state transition of the control state by applying safety data that the gateway device has received from the safety input/output unit to state transition information that indicates a state transition concerning the control state; and
generating, when the control state has transitioned from the non-safety state to the safety state, safety data that indicates the safety state and is to be transmitted to the safety input/output unit.

10. A non-transitory computer readable medium storing a gateway control program to control a gateway device that relays communication of safety data between a safety input/output unit and a safety controller that controls the safety input/output unit so as to establish a safety connection between the safety input/output unit and the safety controller, the safety input/output unit and the safety controller being included in a safety control system, the gateway device being a computer, the gateway control program causing the gateway device to execute:
a state monitoring control process of managing a control state that is a state corresponding to a state of the safety control system and is one of a safety state and a non-safety state, and controlling a state transition of the control state by applying safety data that the gateway device has received from the safety input/output unit to state transition information that indicates a state transition concerning the control state; and
a safety control process of generating, when the control state has transitioned from the non-safety state to the safety state, safety data that indicates the safety state and is to be transmitted to the safety input/output unit.
